(19) United States
(12) Patent Application Publication
(10) Pub. No.: US 2026/0052428 A1
(43) Pub. Date: Feb. 19, 2026

(54) RESOURCE MANAGEMENT FOR PREEMPTION

(71) Applicant: Samsung Electronics Co., Ltd., Suwon-si (KR)

(72) Inventors: Yue Qi, Plano, TX (US); Peshal Nayak, Plano, TX (US); Boon Loong Ng, Plano, TX (US); Bilal Sadiq, Plano, TX (US); Rubayet Shafin, Frisco, TX (US); Vishnu Vardhan Ratnam, Frisco, TX (US)

(21) Appl. No.: 19/291,490

(22) Filed: Aug. 5, 2025

Related U.S. Application Data
(60) Provisional application No. 63/683,022, filed on Aug. 14, 2024.
(60) Provisional application No. 63/710,353, filed on Oct. 22, 2024.
(60) Provisional application No. 63/749,255, filed on Jan. 24, 2025.
(60) Provisional application No. 63/755,704, filed on Feb. 7, 2025.

(51) Int. Cl. H04W 28/06; H04L 67/104; H04W 74/0808

(52) U.S. Cl. CPC H04W 28/06; H04L 67/104; H04W 74/0808

(57) ABSTRACT

A first electronic device includes a transceiver configured to, during a TXOP held by the first electronic device, receive, from a second electronic device, a low latency indication (LLI) indicating a low latency traffic (LLT) request of the second electronic device corresponding with at least one of an uplink traffic request, a downlink traffic request, and a P2P traffic request, and transmit, in response to receipt of the LLI, an indication for one of an RDG or TXOP sharing for the second electronic device. The first electronic device also includes a processor operably coupled to the transceiver. The processor is configured to cause the first electronic device to refrain from transmitting non-LL data within the TXOP during an LLT window. The LLT window is a duration within the TXOP corresponding with the RDG or TXOP sharing in which the second electronic device may exchange the LLT or P2P traffic.

### CROSS-REFERENCE TO RELATED APPLICATION(S) AND CLAIM OF PRIORITY

This application claims priority under 35 U.S.C. § 119(e) to U.S. Provisional Patent Application No. 63/683,022 filed on Aug. 14, 2024, U.S. Provisional Patent Application No. 63/710,353 filed on Oct. 22, 2024, U.S. Provisional Patent Application No. 63/749,255 filed on Jan. 24, 2025, and U.S. Provisional Patent Application No. 63/755,704 filed on Feb. 7, 2025. The above-identified provisional patent applications are hereby incorporated by reference in their entirety.

### TECHNICAL FIELD

This disclosure relates generally to wireless networks. More specifically, this disclosure relates to resource management for preemption.

### BACKGROUND

Wireless Local Area Network (WLAN) technology allows devices to access the internet in the 2.4 GHz, 5 GHz, 6GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for resource management for preemption.

In one embodiment, a first electronic device is provided. The first electronic device includes a transceiver configured to, during a transmission opportunity (TXOP) held by the first electronic device, receive, from a second electronic device, a low latency (LL) indication (LLI) indicating an LL traffic (LLT) request of the second electronic device corresponding with at least one of an uplink (UL) traffic request, a downlink (DL) traffic request, and a peer-to-peer (P2P) traffic request, and transmit, in response to receipt of the LLI, an indication for one of a reverse direction grant (RDG) or TXOP sharing for the second electronic device. The first electronic device also includes a processor operably coupled to the transceiver. The processor is configured to cause the first electronic device to refrain from transmitting non-LL data within the TXOP during an LLT window. The LLT window is a duration within the TXOP corresponding with the RDG or TXOP sharing in which the second electronic device may exchange the LLT or P2P traffic.

In another embodiment, a second electronic device is provided. The second electronic device includes a processor, and a transceiver operably coupled to the processor. The transceiver is configured to, during a TXOP held by a first device, (i) transmit, to the first electronic device, an LLI indicating an LLT request of the second electronic device corresponding with at least one of an UL traffic request, a DL traffic request, and a P2P traffic request, (ii) receive, from the first electronic device, an indication for one of a reverse RDG or TXOP sharing for the second electronic device, and (iii) transmit, during an LLT window, the at least one of UL traffic request, DL traffic or P2P traffic. The LLT window is a duration within the TXOP corresponding with the RDG or TXOP sharing in which the second electronic device may exchange the LLT or P2P traffic.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents and standards descriptions are hereby incorporated into the present disclosure as if fully set forth herein:
[1] IEEE 802.11-2020, “Wireless LAN Medium Access Control (MAC) and Physical Layer (PHY) Specification”
[2] IEEE P802.11ax/D8.0
[3] IEEE P802.11be/D5.0

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example wireless network where infrastructure traffic and non-infrastructure traffic coexist according to embodiments of the present disclosure;

FIG. 4 illustrates an example of power management of a third party in DL preemption according to embodiments of the present disclosure;

FIG. 5 illustrates an example of power management of a third party in UL preemption according to embodiments of the present disclosure;

FIG. 6 illustrates an example of a preemption window with multiple STAs according to embodiments of the present disclosure;

FIG. 7 illustrates an example of multiple preemption windows within a TXOP according to embodiments of the present disclosure;

FIG. 8 illustrates an example of preemption with a window enabled and disabled according to embodiments of the present disclosure;

FIG. 9 illustrates an example of preemption with window assignment according to embodiments of the present disclosure;

FIG. 10 illustrates an example framework for a preemption window according to embodiments of the present disclosure;

FIG. 11 illustrates an example of a contention window in preemption according to embodiments of the present disclosure;

FIGS. 12A and 12B illustrate examples of last minute bounds according to embodiments of the present disclosure;

FIG. 13 illustrates an example of an LL RDG window in a TXOP according to embodiments of the present disclosure;

FIG. 14 illustrates an example of an RDG according to embodiments of the present disclosure;

FIG. 15 illustrates an example of an RD response request for a long response duration according to embodiments of the present disclosure;

FIG. 16 illustrates an example of an RD responder request for a long response duration by RTS/CTS according to embodiments of the present disclosure;

FIG. 17 illustrates an example of an RD responder request for a long response duration by CTS according to embodiments of the present disclosure;

FIG. 18 illustrates an example of an RD responder request for a long response duration by MU-RTS/CTS according to embodiments of the present disclosure;

FIG. 19 illustrates an example of an RD responder request for a further TXOP for LL traffic according to embodiments of the present disclosure;

FIG. 20 illustrates an example of indicating LL in the middle of a TXOP according to embodiments of the present disclosure;

FIG. 21 illustrates an example of indicating LL by embedment in a CTS frame in the middle of a TXOP according to embodiments of the present disclosure;

FIG. 22 illustrates an example method for LL-session setup between two STAs according to embodiments of the present disclosure;

FIG. 23 illustrates an example method for LL-session setup between three STAs according to embodiments of the present disclosure;

FIG. 24 illustrates an example of a STA staying awake during a whole preemptable TXOP according to embodiments of the present disclosure;

FIG. 25 illustrates an example of dynamic PSM where a STA is awake when LLT arrives according to embodiments of the present disclosure;

FIG. 26 illustrates an example of dynamic PSM where a STA is awake when preemption windows activate according to embodiments of the present disclosure;

FIG. 27 illustrates an example of dynamic PSM where a STA is awake when preemption windows activate with constraints according to embodiments of the present disclosure; and

FIG. 28 illustrates an example method for resource management preemption according to embodiments of the present disclosure.

### DETAILED DESCRIPTION

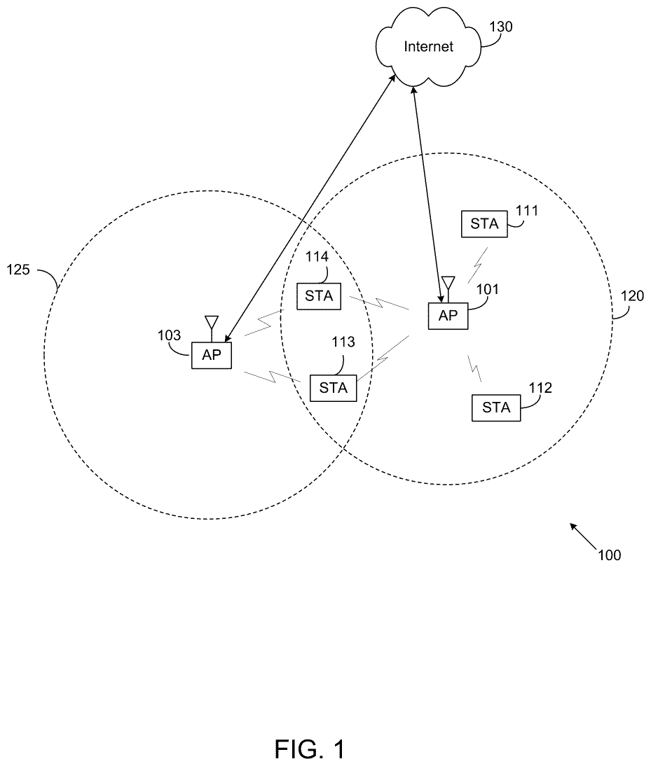

FIGS. 1 through 28, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

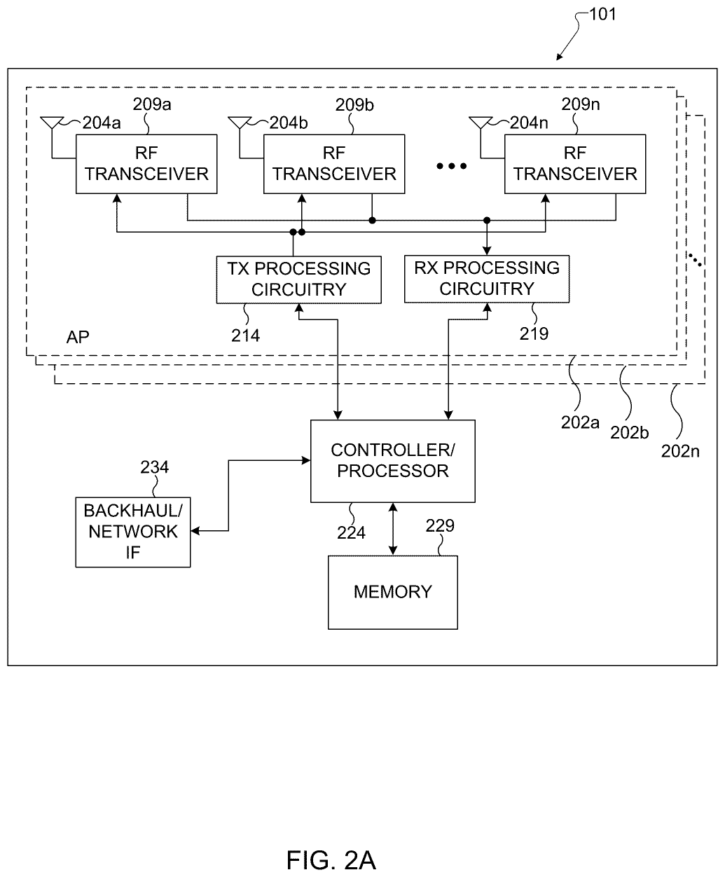

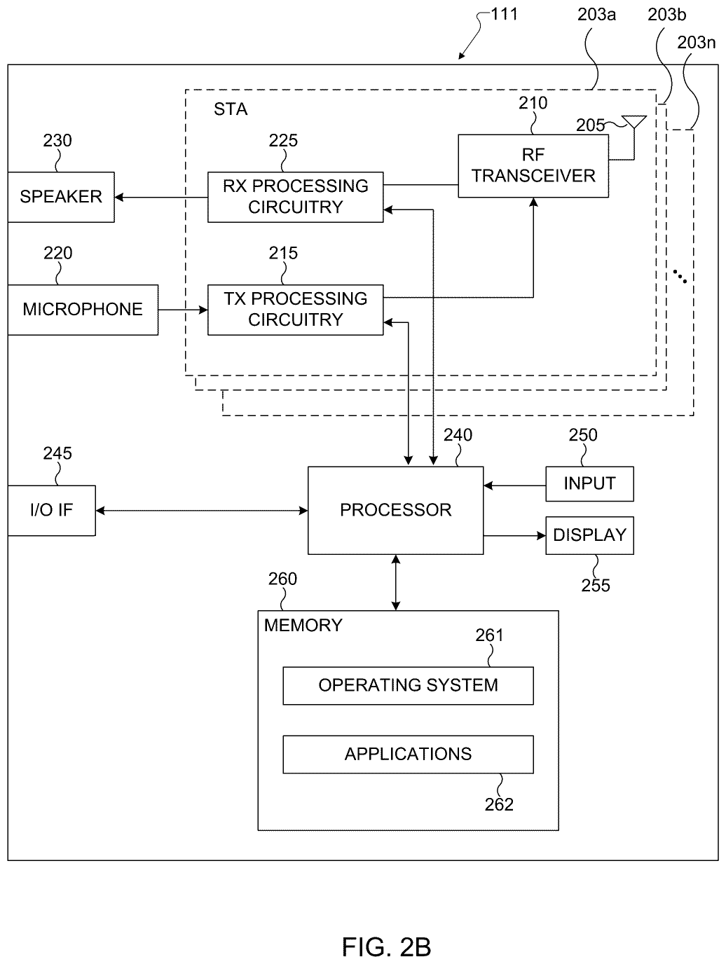

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighed differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Reduced channel access delay for the low-latency traffic required by real-time applications (RTAs) (such as metaverse, augmented and virtual reality, robotics, industrial automation for industrial IoT, logistics and smart agriculture) is a significant consideration for wireless networks. As shown in Table 1 below, some use cases require less than 5 ms for latency and 2 ms for jitter. Lower latency leads to better customer experience (especially worst-case latency/jitter).

TABLE 1
Channel access categories

| | Range for delay | Example | | |
|---|---|---|---|---|
| | tolerance d | values of d | Example application categories | Feature requirements |
| 1 | d ≤ TXOP limit | Few | Cloud gaming, AR/VR (e.g., | Traffic may not survive when the |
| | | milliseconds | remote surgery), live streaming | current TXOP ends. |
| | | | services, high accurate industrial | Preemption or a low latency |
| | | | automation, etc. | indication requesting actions from |
| | | | | TXOP holder can enable the LL |
| | | | | transmission within the TXOP. |
| 2 | TXOP limit < | Close to | AR/VR (e.g., multiplayer | Traffic may survive not being served |
| | d ≤ CA | 10 ms | gaming), online gaming, some | in the same TXOP where it arrives but |
| | | | real time video applications, | cannot incur a long channel access |
| | | | robotics. | delay. |
| | | | | Solution that can enable channel |
| | | | | access faster than legacy channel |
| | | | | access are needed. |
| 3 | CA delay << d | Few 10 s of | Video call, audio call, non-real | Legacy channel access |
| | | ms | time services such as streaming, | |
| | | | web browsing, file downloads, | |
| | | | etc. | |

The latency requirements for different RTAs can be different and the corresponding solutions can be specific. Based on the range of delay tolerance, three categories can be classified as shown in Table 1. For category 1, the delay bound is within the transmission opportunity (TXOP) limit, and traffic may not survive when the current TXOP ends. Therefore, for category 1, the low latency (LL) traffic (LLT) may need to be scheduled in the current TXOP. Solutions such as preemption can enable transmission of the LLT within the TXOP.

For category 2, the delay bounds are greater than the TXOP limit, but smaller than the channel access delay. For category 2, traffic may survive not being served in the same TXOP where the traffic arrives, but the traffic cannot incur a long channel access delay. Solutions for transmitting traffic within the delay bounds of category 2 should enable channel access faster than legacy channel access.

For category 3, some traffic with no quality of service (QoS) requirement may have a long channel access delay tolerance, (e.g., a few 10s of microseconds)

Various embodiments of the present disclosure provide mechanisms to enable transmission of category 1 traffic as shown in Table 1, in which the LLT is expected to be transmitted by the end of the TXOP. For example, various embodiments of the present disclosure may provide preemption as described herein.

Various example use case categories for preemption are shown in Table 2.

TABLE 2
Use case categories in preemption

| | TXOP | TXOP | DL/UL TXOP | Preemptor | LLT | LLT | |
|---|---|---|---|---|---|---|---|
| | holder | responder | Traffic direction | (LL STA) | receiver | Direction | Description |
| Case 1 | AP | STA1 | DL, AP → | AP | STA2 | DL, AP → | TXOP holder |
| | | | STA1 | | | STA2 | preempts its own |
| | | | | | | | TXOP. Infra |
| | | | | | | | preempts infra. |
| Case 2 | AP | STA1 | DL, AP → | STA2 | AP | UL, STA2 | 3^{rd} party preempts |
| | | | STA1 | | | → AP | infra |
| Case 3 | AP | STA1 | DL, AP → | STA2, | AP | UL, STA2 & | 3^{rd} party preempts |
| | | | STA1 | STA3 | | STA3 → AP | infra. |
| Case 4 | AP | STA1 | DL, AP → | STA1 | STA1 | P2P, STA2 | Non-infra (P2P) |
| | | | STA1 | | | → STA1 | preempts infra. |
| Case 5 | AP | STA1 | DL, AP → | STA1 | AP | UL, STA1 | TXOP responder |
| | | | STA1 | | | → AP | preempts TXOP |
| | | | | | | | holder. Reversed |
| | | | | | | | TXOP. |
| Case 6 | AP | STA1 | DL, AP → | STA1 | STA2 | P2P, STA1 | Non-infra (P2P) |
| | | | STA1 | | | → STA2 | preempts infra. |
| Case 7 | STA1 | AP | UL, STA1 → | STA1 | STA2 | P2P, STA1 | TXOP holder |
| | | | AP | | | → STA2 | preempts its own |
| | | | | | | | TXOP. Non-infra |
| | | | | | | | (P2P) preempts |
| | | | | | | | infra. |
| Case 8 | STA1 | AP | UL, STA1 → | STA2 | AP | UL, STA2 | 3^{rd} party preempts |
| | | | AP | | | → AP | infra. |
| Case 9 | STA1 | AP | UL, STA1 → | STA2, | AP | UL, STA2 & | 3^{rd} party preempts |
| | | | AP | STA3 | | STA3 → AP | infra. |
| Case 10 | STA1 | AP | UL, STA1 → | STA2 | STA1 | P2P, STA2 | Non-infra (P2P) |
| | | | AP | | | → STA1 | preempts infra. |
| Case 11 | STA1 | AF | UL, STA1 → | AP | STA2 | DL, AP → | Infra preempts infra. |
| | | | AP | | | STA2 | |
| Case 12 | STA1 | AP | UL, STA1 | AP | STA1 | DL, AP → | TXOP responder |
| | | | AP | | | STA1 | preempts TXOP |
| | | | | | | | holder. Reversed |
| | | | | | | | TXOP. |
| Case 13 | AP | STA1 | UL trigger, | STA2 | AP | UL, STA2 | 3^{rd} party preempts |
| | | | STA1 → AP | | | → AP | infra. |
| Case 14 | AP | STA1 | UL trigger, | STA2 | STA1 | P2P, STA2 | Non-infra (P2P) |
| | | | STA1 → AP | | | → STA1 | preempts infra. |

In the example of Case 1 in Table 2, the TXOP holder is an AP, and the TXOP responder is a first station (“STA1”). The ongoing TXOP is a DL TXOP where the AP transmits a DL physical layer protocol data unit (PPDU) to STA1. The preemptor is the AP which has LLT and will send a LL PPDU to a second station (“STA2”) who is the LLT receiver. STA2 may associate with the AP in one basic service set (BSS). The direction of the LLT is a DL transmission from the AP to STA2. Case 1 can be described as a TXOP holder preempts its own TXOP, and infrastructure preempts infrastructure.

Similarly, in the example of case 3 of Table 2, the TXOP holder and TXOP responder remain the same as case 1. STA2 (and/or a third station [“STA3”]) is the preemptor and has UL LLT for the AP, which preempts the transmission from infrastructure. Such cases may be classified as a third party preempts infrastructure.

Many existing preemption mechanisms assume that LLT arrives in a timely enough manner to preempt a TXOP and transmit successfully within the TXOP limit. However, in some cases, the LLT may not arrive timely, and the LLT may require management from the TXOP holder. For example, there could be a backlog of LLT flows waiting for preemption at the beginning of the TXOP. The backlog of LLT in the queue may not win channel access, and the LLT may have to wait for preemption. In some embodiments, the TXOP holder may manage this LLT to achieve better management and fairness among the LLT and the TXOP holder's own traffic.

In another example, LLT flows may arrive timely, but with different types/directions of traffic (e.g., DL, UL, and P2P), and how to satisfy legitimate LLT during a single TXOP may be unclear. In some embodiments, management of legitimate LLT may include one or more of preempting before a delay bound of the LLT, buffer state controlling, etc.

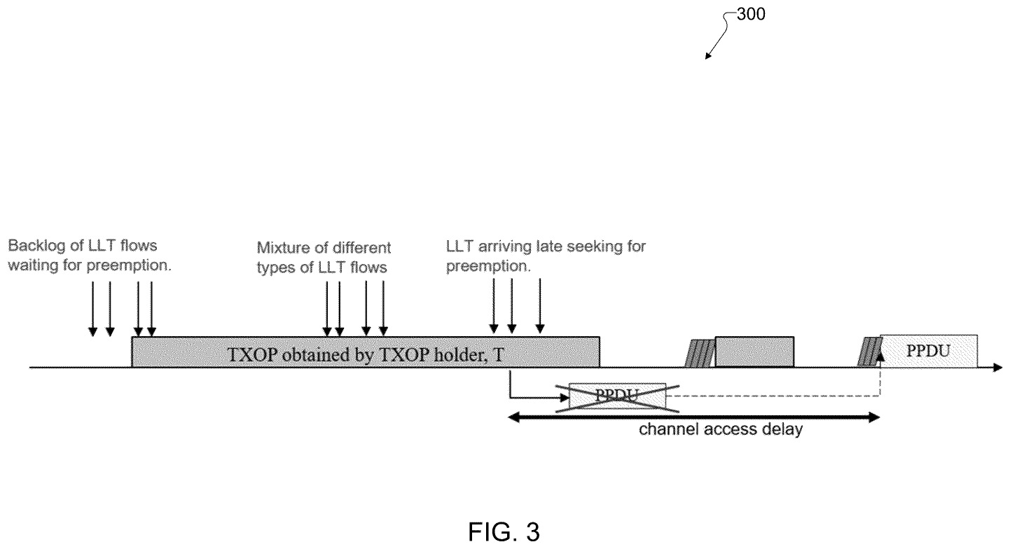

In still another example, LLT flows may arrive near the end of the TXOP and seek preemption opportunities. For example, the LLT be from the end of a backlog, and may not have a chance to preempt earlier, as shown in FIG. 3.

FIG. 3 illustrates an example 300 of late LLT arrival according to embodiments of the present disclosure. The embodiment of late LLT arrival of FIG. 3 is for illustration only. Different embodiments of late LLT arrival could be used without departing from the scope of this disclosure.

In the example of FIG. 3, a backlog of LLT flows is awaiting preemption of a TXOP held by a TXOP holder “T”. Late during the TXOP, LLT from the backlog arrives too late to preempt the TXOP for timely transmission during the TXOP. This creates a channel access delay for the late arriving LLT.

Although FIG. 3 illustrates one example 300 of late LLT arrival, various changes may be made to FIG. 3. For example, various changes to amount of LLT, the arrival time of the LLT, etc., could be made according to particular needs.

Late arriving LLT may ultimately be suspended or dropped, which may result in a longer channel access delay and bad user experience. Better management of the backlog and mixture of the LLT may permit the LLT to transmit within the TXOP and end the backlog. However, improvement is desired to avoid channel access delay when late LLT arrives. Various embodiments of the present disclosure may provide mechanisms for avoiding channel access delay with LLT.

A reverse direction (RD) grant (RDG) facilitates efficient bidirectional communication by allowing a STA (RD responder) that has just received data to immediately transmit data back to an RD initiator. In some embodiments provide an RDG with preemption is provided as an enhancement to provide more flexibility and use cases.

According to existing RD procedures, it is not always the case that an RD initiator permits an LL transmission simply because the RD responder possesses LLT. The RD initiator is motivated to start the RDG when the RD initiator has LLT or when the RD initiator is prompted to do so. Consequently, if the RD responder has LLT, it may need to wait for the RD initiator to initiate the RD when the RDG or additional PPDU subfield is set to 1. The RD responder tends to be passive and has limited available actions.

While an LL indication (LLI) may convey urgency along with duration and timing information, the RD initiator might still allocate only a brief period for the RD responder. Therefore, effective resource management is desirable during the RDG. For instance, in some embodiments, the RD initiator and responder may negotiate a duration or LL window for the RD responder, allowing the RD responder to utilize the duration and bandwidth more efficiently.

Moreover, the RD responder may experience prolonged low-latency traffic or extended response bursts during the RDG, which could require additional time for RD transmission or even further TXOP requests. Current wireless networking specifications do not address these scenarios adequately, and the actions involved are not clearly articulated. Various embodiments of the present disclosure provide mechanisms for managing RDG resources.

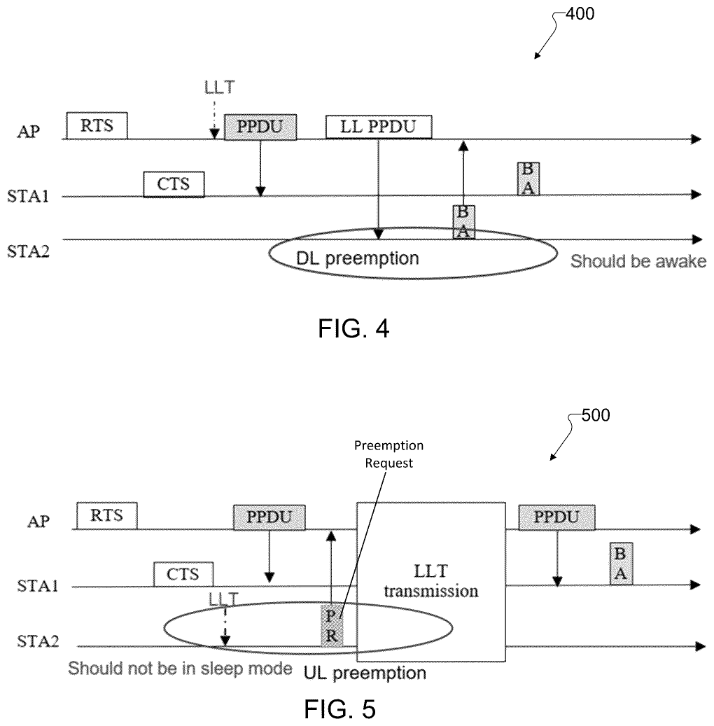

In Table 2 above, in Case 1, Case 6, Case 7, and Case 11, the LLT receiver should not be in power saving (PS) mode. Otherwise, the LLT receiver will not be able to receive the LLT. An example of this issue is shown in FIG. 4.

FIG. 4 illustrates an example 400 of power management of a third party in DL preemption according to embodiments of the present disclosure. The embodiment of power management of a third party in DL preemption of FIG. 4 is for illustration only. Different embodiments of power management of a third party in DL preemption could be used without departing from the scope of this disclosure.

In the example of FIG. 4, the AP receives LLT intended for STA2 while transmitting traffic to STA1. The AP then preempts the DL traffic to STA1 and transmits the LLT to STA2. However, if STA2 is in a power saving mode, STA2 will be unable to receive the LLT traffic.

Although FIG. 4 illustrates one example 400 of power management of a third party in DL preemption, various changes may be made to FIG. 4. For example, various changes to transmission times, etc. could be made according to particular needs.

Various embodiments of the present disclosure provide mechanisms to keep devices awake to receive LLT traffic.

In Table 2 above, for Cases, 2-5 and Cases 8-10, because the LLT receiver is either a TXOP holder or TXOP responder, there is no power save issue for the LLT receiver. However, if the LLT transmitter (3rd party) is in sleep mode during a preemptable TXOP or not aware of the preemptable TXOP, the LLT transmitter will miss the transmission opportunity. An example of this issue is shown in FIG. 5.

FIG. 5 illustrates an example 500 of power management of a third party in UL preemption according to embodiments of the present disclosure. The embodiment of power management of a third party in UL preemption of FIG. 5 is for illustration only. Different embodiments of power management of a third party in UL preemption could be used without departing from the scope of this disclosure.

In the example of FIG. 5, the STA2 receives LLT while the AP is transmitting traffic to STA1. STA2 then preempts the DL traffic to STA1 and transmits the LLT. However, if STA2 is in a power saving mode, STA2 will be unaware of the TXOP to preempt to transmit the LLT.

Although FIG. 5 illustrates one example 500 of power management of a third party in UL preemption, various changes may be made to FIG. 5. For example, various changes to transmission times, etc. could be made according to particular needs.

In existing wireless networks, STAs may remain in a sleeping mode during RTS/CTS since the STA is not allowed to transmit/preempt during RTS/CTS. Various embodiments of the present disclosure provide mechanisms to keep devices awake during a preemptable TXOP.

In existing wireless networks, low latency session setup and negotiation procedures are unclear. Various embodiments of the present disclosure provide mechanisms for low latency setup and negotiation.

As noted above, various embodiments of the present disclosure may provide mechanisms for avoiding channel access delay with LLT.

In some embodiments, one of a TXOP holder and/or a TXOP responder may allow preemption and interruption by LLT during transmission of other traffic by the TXOP holder or the TXOP responder during the TXOP. In embodiments such as these, the TXOP may be referred to as a low latency TXOP or a preemptable TXOP. In some embodiments, a preemptable TXOP may be defined such that a duration of the preemptable TXOP is a time in which a STA is allowed to interrupt control of the medium of the preemptable TXOP.

In some embodiments, a TXOP holder may indicate whether a TXOP is a preemptable TXOP. For example, in some embodiments the TXOP holder may set a bit in a field of frame (e.g., a control frame such as a request to send [RTS] frame, or a multi-user RTS [MU-RTS]) frame indicating whether the TXOP is a preemptable TXOP. For example, if the bit in the field is set to 0, in some embodiments this may indicate that the TXOP is a non-preemptable TXOP, and if the bit in the field is set to 1, this may indicate that the TXOP is a preemptable TXOP. However, it should be understood that either setting of the bit may be used to indicate that the TXOP is preemptable or non-preemptable.

As used herein, the term preemption duration or preempted duration may refer to a time window within a defined period when a preemption related frame exchange including LLT starts until transmission of the LLT ends. In some embodiments, a preemption may be limited in duration to a predefined time. The predefined time may be referred to as a preemption duration limit.

In some embodiments, preemption may be permitted within a predetermined time within a TXOP. This predetermined time may be referred to as a preemption window. In some embodiments, the preemption window may be managed by an AP. In some embodiments, the preemption window may be managed by the TXOP holder. In some embodiments, the preemption window may be negotiated with the TXOP holder among one or more STAs.

In some embodiments, a TXOP may include a plurality of preemption windows. In embodiments such as these, the preemption duration limit for the TXOP may be a time equal to a sum of each preemption window within the TXOP. A maximum duration for a preemption duration limit may be referred to herein as τ*.

In some embodiments, a STA with LLT (LL STA) may be allowed to preempt a TXOP within a particular time window (i.e., during a preemption window). In these embodiments, the TXOP holder may may transmit the TXOP holder's regular traffic outside of the time window, (e.g., before the preemption window) the TXOP holder may regain use of a remainder of the TXOP if the preemption finishes before the end of the TXOP.

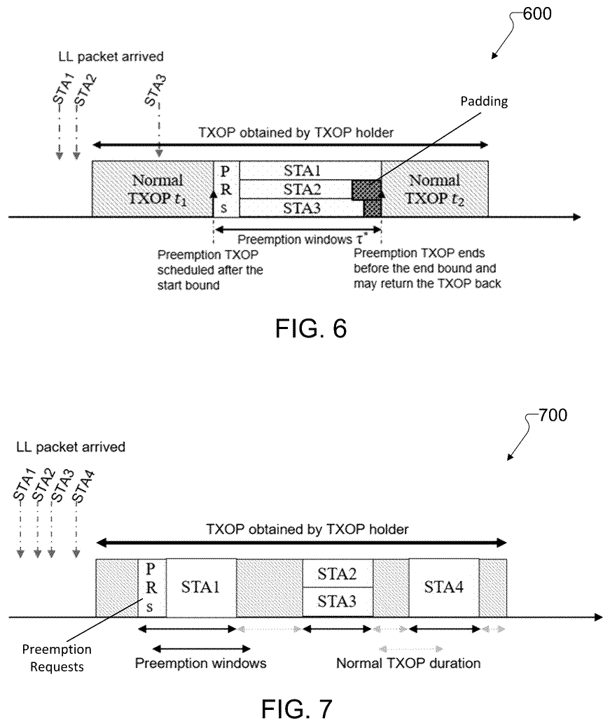

In some embodiments, a TXOP holder may assign a preemption duration portion of the TXOP for preemption, and the TXOP holder may retain a remainder of the TXOP for regular transmissions by the TXOP holder. An example is shown in FIG. 6.

FIG. 6 illustrates an example 600 of a preemption window with multiple STAs according to embodiments of the present disclosure. The embodiment of a preemption window of FIG. 6 is for illustration only. Different embodiments of a preemption window with multiple STAs could be used without departing from the scope of this disclosure.

In the example of FIG. 6, a duration t₁ has been assigned at the beginning of a TXOP by the TXOP holder for regular transmission of the TXOP's own traffic. Similarly, a duration t₂ has been assigned at the end of the TXOP holder for regular transmission of the TXOP's own traffic. Preemption may occur during the remainder of the time of the TXOP between duration t₁ and duration t₂. In other words, after duration t₁, LL traffic from different STAs may preempt the TXOP. The LLT from the different STAs may have different directions (e.g., UL or DL LLT may preempt an UL TXOP or a DL TXOP). Limiting the preemption duration may help to ensure that there will be enough time for normal transmissions of the TXOP holder during the TXOP.

In some embodiments, a preempting STA (or ultra high reliability [UHR] LL STA) may have awareness of the preemptable TXOP limit and/or preemption duration limit or a start and end time for TXOP preemption. This awareness may provide fairness for the TXOP holder and the TXOP responder regarding the use of the TXOP during duration t₁ and duration t₂.

Although FIG. 6 illustrates one example 600 of a preemption window with multiple STAs, various changes may be made to FIG. 6. For example, various changes to duration sizes, the number of durations, etc. could be made according to particular needs.

A preemption window such as shown in FIG. 6 may be indicated by various information items as shown in Table 3.

TABLE 3
Preemption window information items

| Subfield | Description |
|---|---|
| Start time stamp | A time before which an LL STA should not |
| | preempt the TXOP |
| End time stamp | A time after which an LL STA should not |
| | preempt the TXOP |
| Preemption window | The maximum duration for a preemption window |
| duration limit | within the TXOP. |
| Portion of the TXOP | This item indicates the portion of the TXOP |
| for preemption | available for preemption. For example, if 50% of |
| | the TXOP is preemptable, the TXOP holder may |
| | allow preemption within 50% of the time |
| | allocated to the TXOP. Otherwise, preemption |
| | during the TXOP is restricted. |

In some embodiments, a preemption window may occupy the entirety of a preemptable TXOP. In embodiments such as these, the maximum duration of a preemption window may be the limits of the preemptable TXOP. In some embodiments, a preemption window may be available for preemption even when no LLT is in the TXOP. In some embodiments, the volume of LLT may insufficient to utilize an entire preemption window, and there may be some residual time in the preemption window after transmission of the LLT.

In some embodiments, a preemption window may have a start and end time with a maximum duration τ*. In some embodiments, a preemption window may not have a specific start and end time, and the TXOP holder may track the resources consumed by preemption. In embodiments such as these, an information item (e.g., the portion of the TXOP available for preemption) can be indicated for the preemption window as shown in Table 1.

In some embodiments, a preemptable TXOP may be divided into several preemption windows, and the TXOP holder may be able to configure whether preemption is enable or disabled for any particular preemption window within the TXOP. In some embodiments, multiple STAs may be assigned to each preemption window, and each STA may be assigned different resources (e.g., frequencies) for that preemption window. In embodiments such as these, preemption may occur different random access-resource units (RA-RUs) for the specific STAs. In some embodiments, the preemption windows for the specific STAs may be indicated in an association ID (AID) field.

In some embodiments, if LLT is not time aligned during preemption with OFDMA for multiple STAs, padding may be used to align the LLT packets as shown in FIG. 6. In some embodiments, the TXOP holder may select the maximum preemption duration among the LL STAs and assign this maximum preemption duration to all of the LL STAs.

In some embodiments, multiple preemption windows (either separately or continuously) may be assigned for multiple STAs or LL traffic by a TXOP holder, similar as shown in FIG. 7.

FIG. 7 illustrates an example 700 of multiple preemption windows within a TXOP according to embodiments of the present disclosure. The embodiment of multiple preemption windows within a TXOP of FIG. 7 is for illustration only. Different embodiments of multiple preemption windows within a TXOP could be used without departing from the scope of this disclosure.

In the example of FIG. 7, three separate preemption windows have been assigned in the TXOP. The first preemption window is assigned to STA1, the second preemption window is assigned to STA2 and STA3, and the third preemption window is assigned to STA4.

Although FIG. 7 illustrates one example 700 of multiple preemption windows within a TXOP, various changes may be made to FIG. 7. For example, various changes to duration sizes, the number of preemption windows, etc. could be made according to particular needs.

Preemption windows such as shown in FIG. 7 may be indicated by various information items as shown in Table 4.

TABLE 4
Preemption window information items

| Subfield | Description |
|---|---|
| Number of Preemption | A number of preemption window that |
| windows | may occur in each TXOP. |
| Preemption window capability | Indicates whether the preemption window |
| | is enabled or disable. A bit 0 may indicate |
| | disabled, and a bit 1 may indicate enabled |
| Number of STA supported in | The number of STAs in the resources |
| each preemption. | (e.g., via OFDMA) of the preemption |
| | window |
| Preemption window duration | The maximum duration for each |
| limit | preemption window within the TXOP. |
| Start time stamp list | A time stamp list indicating times before |
| | which LL STAs should not preempt the |
| | TXOP |
| End time stamp list | A time stamp list indicating times after |
| | which LL STAs should not preempt the |
| | TXOP |
| Preemption order | An order list that the LLT or the LL STAs |
| | are going to preempt the TXOP. |
| Preemption window duration | Indicates the duration mechanism for each |
| mechanism | preemption window. Each duration of |
| | preemption window may follow binary |
| | back-off, or may have a fixed duration. |

In some embodiments, a STA may initiate preemption of a preemptable TXOP by transmitting a preemption request (PR) frame. A PR frame may also be referred to as a low latency indication (LLI). In some embodiments, a preemption request frame may be contained within a multi-STA BlockAck frame. In some embodiments, a preemption request frame may be contained within a buffer status report (BSRP) frame. In some embodiments, a preemption request frame may be contained within a clear to send (CTS) frame.

In some embodiments, PR frames/LLIs from different STAs may be transmitted at the beginning of a preemption window. In some embodiments, a preemption request frame may be transmitted by a STA at the beginning of a preemptable TXOP to inform the TXOP holder preemption is requested during the preemption window.

In some embodiments, a PR frame may include a bit indicating a need to transmit LTT, and a bit indicating a basic service set identifier (BSSID). An example field for a PR frame including these bits is shown below:

| | |
|---|---|
| LLT for preemption | BSSID |

In the example field above, when the LTT for preemption bit is set to 1, this may indicate that LTT is queued and the STA transmitting the PR frame is going to preempt the TXOP. When the BSSID field is set to 1, this may indicate that the preempting STA is preempting the same BSS. When the BSSID field is set to 0, this may indicated that the preempting STA may be from another BSS.

In some embodiments, to enable transmission of LLT within the limits of a TXOP and/or preemption window, the TXOP holder or LL STA may increase their transmission capability (e.g., increasing the number of spatial streams [NSS], modulation coding scheme [MCS], etc.) to accommodate the LTT within the limits of the TXOP and/or preemption window.

In some embodiments, LLT may be assigned to PR flows in different resources (e.g., OFDMA resources) within a preemption window.

In some embodiments, a PR frame/LLI may arrive before a TXOP. In these embodiments, the PR frame/LLI may preempt the TXOP at the very beginning of the TXOP. In embodiments such as these, LLT from different STAs with different directions (i.e., UL or DL LLT preempting a UL TXOP or DL TXOP) may preempt the TXOP after the PR flows are assigned by the TXOP holder.

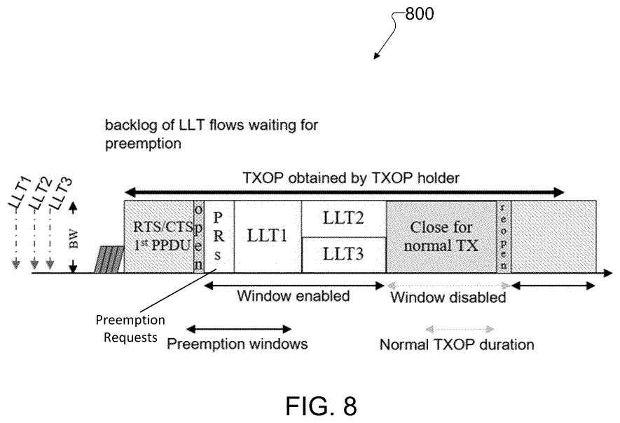

In some embodiments, a STA may transmit a preemption request frame during a TXOP after receiving a first PPDU enabling preemption in the TXOP, as shown in FIG. 8.

FIG. 8 illustrates an example 800 of preemption with a window enabled and disabled according to embodiments of the present disclosure. The embodiment of preemption of FIG. 8 is for illustration only. Different embodiments of preemption with a window enabled and disabled could be used without departing from the scope of this disclosure.

In the example of FIG. 8, the TXOP holder has enabled and opened a preemption window by sending a PPDU indicating that the preemption window is enabled. In the example of FIG. 8, the first PPDU has also disabled preemption in the next window to allow for normal traffic transmission. However, it should be understood that in some embodiments, the first PPDU may not disable or enable multiple preemption windows.

In some embodiments, a bit in the MAC and/or PHY header of the first PPDU may indicate enablement of the preemption window within the TXOP. For example, in some embodiments, a bit in the MAC/PHY header of the PPDU may indicate whether preemption can start after this PPDU. For example, if the bit is set to 1, this may open the window for preemption after the PPDU, and if the bit is set to 0, this may disable the preemption window, and the TXOP holder and responder can continue transmit their non-LL PPDU traffic.

Although FIG. 8 illustrates one example 800 of preemption with a window enabled and disabled, various changes may be made to FIG. 8. For example, various changes to number of preemption windows, the window sizes, etc. could be made according to particular needs.

In some embodiments, a TXOP holder may reopen a preemption window. However, it should be understood that in some embodiments where the TXOP holder reopens the preemption window, preemption of the TXOP by LLT during the preemption window is not necessary.

In some embodiments, when there is a mix of many types of LLT, the preemption window may be opened only for a certain type of the LLT (e.g., a preemption window may be opened for one of UL or DL LLT). In some embodiments, the preemption window may be opened for either UL or DL LLT. In some embodiment, the TXOP holder or preemption granter may assign a resource to the preemption window according to the LLT type. For example, the resource may include a time slot with a specific order of preemption, and frequency resources based on the preemption grant and buffer retrieval.

In some embodiments, the last LL PPDU transmitted in a preemption window may indicate that no more LLT is queued for the preemption window, and the associated preemption may be concluded.

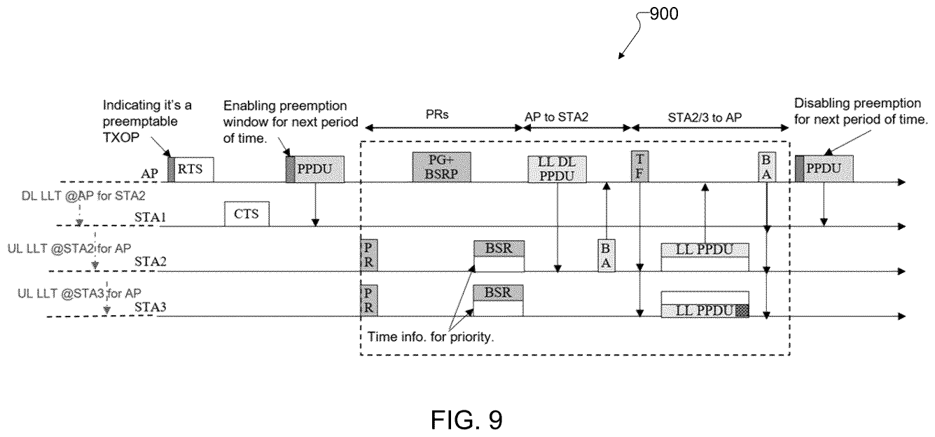

An example of resource management is shown in FIG. 9

FIG. 9 illustrates an example 900 of preemption with window assignment according to embodiments of the present disclosure. The embodiment of preemption of FIG. 9 is for illustration only. Different embodiments of preemption with window assignment could be used without departing from the scope of this disclosure.

In the example of FIG. 9, the AP is the TXOP holder, and STA1 is the TXOP responder. The AP has DL LLT for STA1, while STA2 and STA3 have UL LLT for the AP.

After the AP transmits an RTS to STA1 and receives a CTS from STA1, the AP transmits the first PPDU which enables a preemption window, and preemption requests (PRs) are transmitted by STA2, STA3.

After receiving the PRs, the AP the AP assigns the preemption window by transmitting a preemption grant (PG) frame with a buffer status report poll (BSRP). In some embodiments the preemption grant frame may include information indicating that the first portion of the window is for PR exchanges, the second portion of the window is for DL LLT from the AP to STA1, and the AP may then transmit a trigger frame for STA2, STA3 to transmit their UL LLT.

In some embodiments, the PG may include the preemption duration, and timeout information, an indication whether preemption is granted, etc.

In some embodiments, time information, delay bounds, etc., can be incorporated into a buffer status report (BSR) frame.

In some embodiments, each preemption request that is granted for a preemption window may have identical RA, identical transmission directions, and identical timeout information.

Although FIG. 9 illustrates one example 900 of preemption with window assignment, various changes may be made to FIG. 9. For example, various changes to number of STAs, the traffic direction, etc. could be made according to particular needs.

In some embodiments, if LLT transmission finishes before the request duration or uses less of the preemptable TXOP than requested, no further action may be taken by the preemptor regarding the LLT transmission. In embodiments such as these, the TXOP holder and responder may sense that the channel is available and resume regular PPDU transmission.

In some embodiments, if LLT transmission finishes before the request duration or uses less of the preemptable TXOP than requested, the preemptor may send a contention free (CF)-end frame to end the preemption window early

In some embodiments, the LLT may be aware of the maximum duration of the preemption window and the preemptable TXOP limit. In embodiments such as these, LL STAs and the TXOP holder may try to finish the transmitting the LLT within these windows and limit by adjusting their transmission capability (e.g., increasing the number of spatial streams [NSS], modulation coding scheme [MCS], etc.). In some other embodiments, the LLT transmission may exceed these windows and limit when a preemption extension is required.

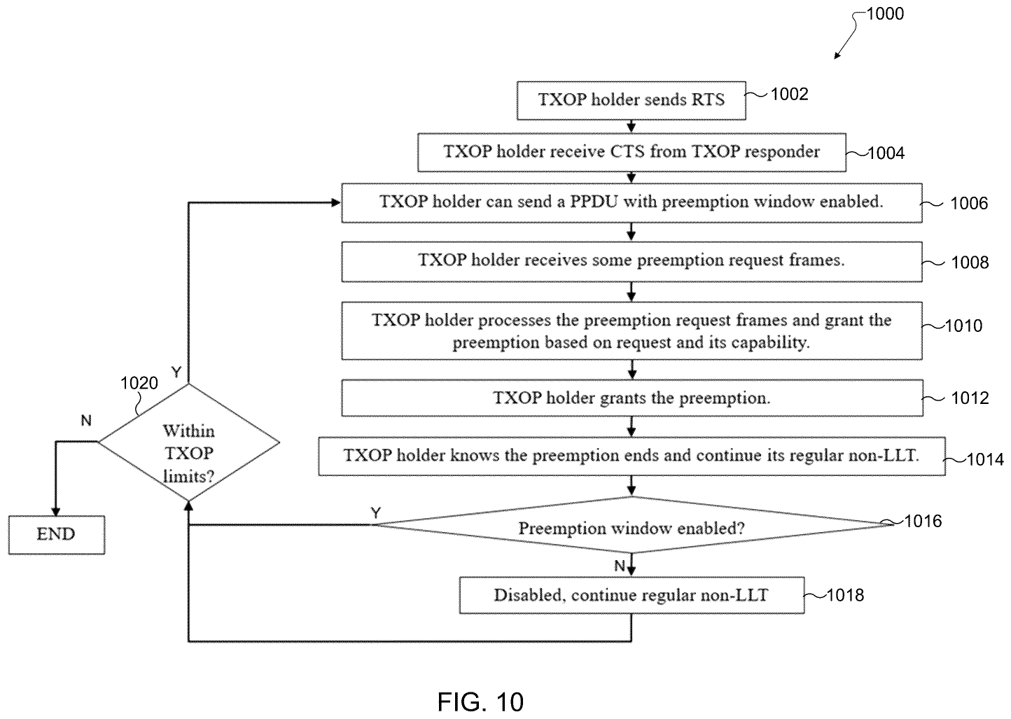

FIG. 10 illustrates an example framework 1000 for a preemption window according to embodiments of the present disclosure. An embodiment of the framework illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a framework for a preemption window could be used without departing from the scope of this disclosure.

In the example of FIG. 10, the framework 1000 begins at step 1002. At step 1002, a TXOP holder (such as the AP of FIG. 10) sends an RTS frame. At step 1004, the TXOP holder receives a CTS frame from a TXOP responder (such as STA1 of FIG. 9). At step 1006, The TXOP holder can send a PPDU enabling a preemption window. At step 1008, if the PPDU of step 1006 enables a preemption window, the TXOP holder may receive some preemption request frames (e.g., from STAs 2 and 3 of FIG. 9).

At step 1010, the TXOP holder processes any preemption request frames received in step 1008 based on the request and its capability. At step 1012, the TXOP grants preemptions based on the processing in step 1010. At step 1014, the TXOP holder determines that the preemption has ended, and continues transmitting or receiving regular non-LTT.

At step 1016, the TXOP holder determines whether a preemption window is enabled. If the preemption window is not enabled, framework 1000 proceeds to step 1018. Otherwise, if the preemption window is enabled, framework 1000 proceeds to step 1020.

At step 1018, the TXOP holder continues to transfer

At step 1020, the TXOP holder determines whether the TXOP is within TXOP limits. If the TXOP is not within limits, framework 100 ends. Otherwise, if the TXOP is within the limits, framework 100 loops to step 1006.

Although FIG. 10 illustrates one example framework 1000 for a preemption window, various changes may be made to FIG. 10. For example, while shown as a series of steps, various steps in FIG. 10 could overlap, occur in parallel, occur in a different order, occur any number of times, be omitted, or replaced by other steps.

In some embodiments, membership within a preemption window may be negotiated before preemption such that the negotiating UHR LL STAs may understand the parameters of preemption, and any STAs not in agreement may preempt.

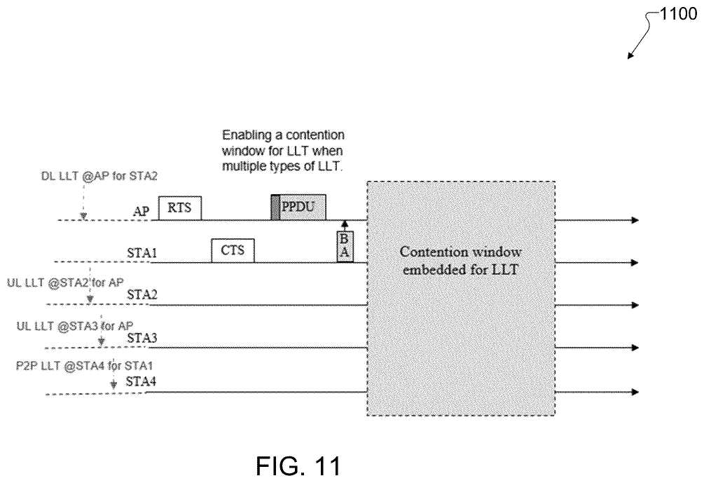

In some embodiments, a contention window may be established within a TXOP in which multiple LL STAs may contend for transmission of their LLT as shown in FIG. 11.

FIG. 11 illustrates an example 1100 of a contention window in preemption according to embodiments of the present disclosure. The embodiment of a contention window of FIG. 11 is for illustration only. Different embodiments of a contention window in preemption could be used without departing from the scope of this disclosure.

In the example of FIG. 11, the AP is the TXOP holder, and STA1 is the TXOP responder. The AP has DL LLT for STA2, while STA2 and STA3 have UL LLT for the AP. STA4 has P2P LLT for STA1.

After the AP transmits an RTS to STA1 and receives a CTS from STA1, the AP transmits a first PPDU which enables a contention window for LLT.

During the contention window, the AP and each of the STAs contend the channel to transmit their respective LLT.

Although FIG. 11 illustrates one example 1100 of a contention window in preemption, various changes may be made to FIG. 11. For example, various changes to window size, the number of contending STAs, etc. could be made according to particular needs.

In some embodiments, a time bound within a preemption window may be defined after which an LL STA cannot preempt. Such a time bound may help assure LL traffic may finish transmitting within the preemptable TXOP limits. In some embodiments, the bound may be defined by the LL STA and the TXOP holder based on their capabilities.

In some embodiments, the TXOP holder may indicate the bound after which LL STA(s) cannot preempt anymore. In some other embodiments, the preempting STAs or LL STAs may negotiate with TXOP holder for the bound.

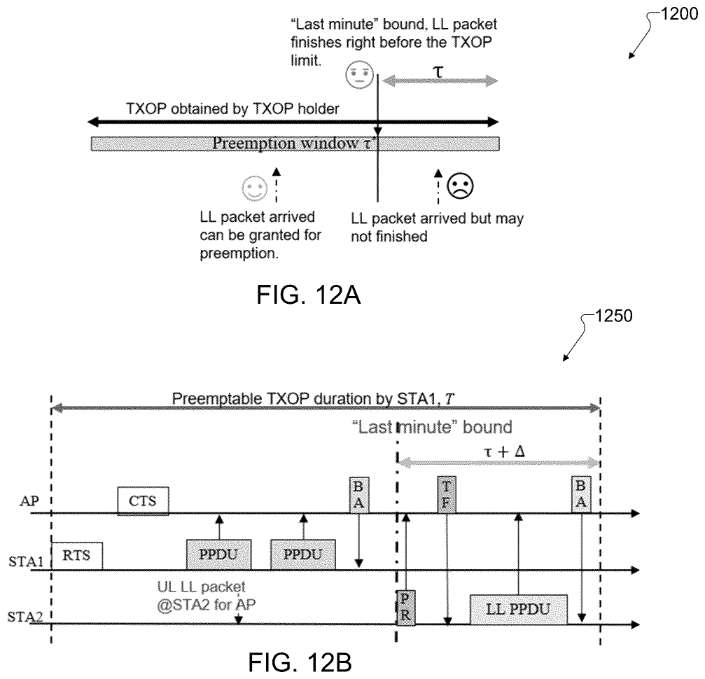

In some embodiments, a “Last minute bound” can be defined T−τ−t₂. In these embodiments, T is the preemptable TXOP duration, and τ can be an estimated value of the request duration for LLT from the preemptor's buffer. t₂ is the duration that the TXOP holder may require for its own regular or LL transmission (for example, as shown in FIG. 6). In some embodiments t₂ can be zero. Examples of last minute bounds are shown in FIG. 12A and FIG. 12B. For multiple STAs, the last-minute bound can be the earliest bound among all the LLT.

FIGS. 12A and 12B illustrate examples 1200 and 1250 of last minute bounds according to embodiments of the present disclosure. The embodiment of last minute bounds of FIGS. 12A and 12B are for illustration only. Different embodiments of last minute bounds could be used without departing from the scope of this disclosure.

In the example of FIGS. 12A and 12B, an LL packet that arrives before the last minute bound may be granted preemption, as it may finish transmission within the TXOP. An LL packet that arrives after the last minute bound may have insufficient remaining time within the TXOP to complete transmission.

In the example of FIG. 12B, STA1 is the TXOP holder, and the AP is the TXOP responder. STA2 has UL LLT for the AP.

After the AP transmits an RTS to STA1 and receives a CTS from STA1, STA1 transmits PPDUs to the AP and is preempted by STA2.

Although FIGS. 12A and 12B illustrate examples 1200 and 1250 of last minute bounds, various changes may be made to FIGS. 12A and 12B. For example, various changes to the preemption window could be made, etc. according to particular needs.

In some embodiments, preemption duration information may be indicated by the TXOP holder. For example, when the TXOP holder is an AP, the required preempted duration and the length of the preemption window information can be advertised by the AP in the enhanced distributed channel access (EDCA) parameter Set element in Beacon and Probe Response frames transmitted by the AP. In another example, when the TXOP holder is non-AP STA, the STA can also advertise in the control frames (RTS/CTS), SCS frames, or negotiation frames beforehand, etc. In embodiments, such as these, the preemption information items can be the items in Table 3 and Table 4.

In some embodiments, the preemption duration information may be requested and/or obtained by the LL STA. The preemption duration information can also be indicated by the LL STA (non-TXOP holder). For example, the preemption duration information can be indicated in a preemption request frame, pre-negotiation frames, SCS etc.

In some embodiments, an LL STA may be able to calculate the “last minute” bound from RTS/CTS, but the TXOP holder and TXOP responder may be unaware of the last minute bound of the LL Sta. In embodiments such as these, there may be a negotiation for granting the preemption.

If the preemption (estimated) could happen within the TXOP holder's limits or before the “last minute bound”, the TXOP holder and/or the LLT receiver can grant the preemption. After the LLT, the preempting STA may return the TXOP to the TXOP holder.

If the indicated duration exceeds the TXOP holder's limits or available preempted window duration, the TXOP holder or the LLT receiver may consider to extend the current TXOP or the current preemption window if needed. The TXOP holder may also reject the preemption request. The LL STAs and/or the TXOP holder may also switch to a high capability mode to accommodate the requirement.

As noted above, various embodiments of the present disclosure provide mechanisms for managing RDG resources.

In some embodiments, an RD initiator may grant a TXOP to an RD responder immediately after the RD initiator receives a LL indication from the RD responder.

In some embodiments, the RD initiator may grant the TXOP to the RD responder at a particular point in time. In some other embodiments, the RD initiator may grant the TXOP to the RD responder before a certain time point in which timing information may be indicated to the RD responder in an acknowledgement frame.

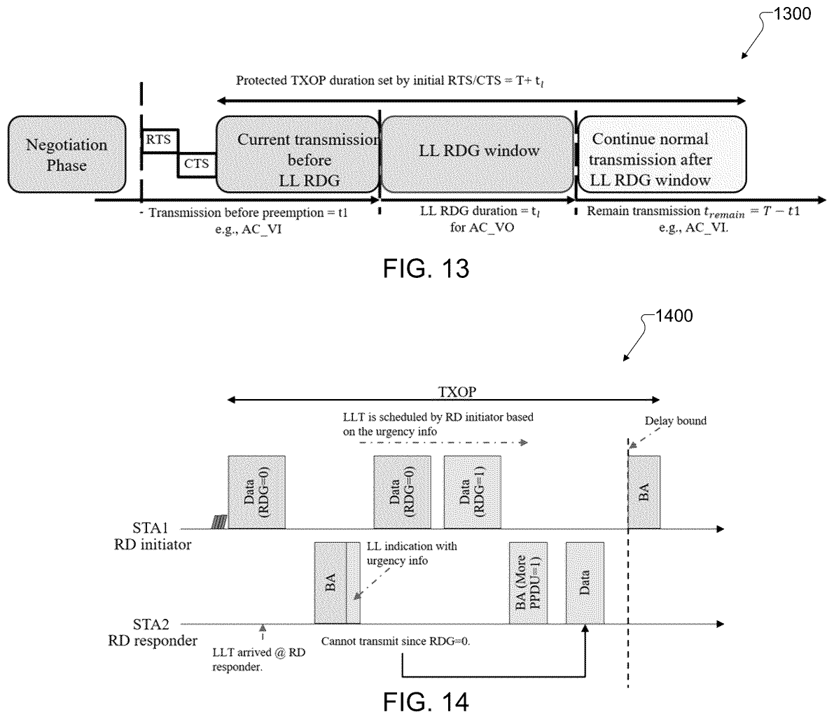

In some embodiments, an LL RDG or an enhanced RDG may negotiate an LL RDG window or service period during which the LL RDG can happen. An example of an LL RDG window embedded in an ongoing transmission is shown in FIG. 13.

FIG. 13 illustrates an example 1300 of an LL RDG window in a TXOP according to embodiments of the present disclosure. The embodiment of an LL RDG window of FIG. 13 is for illustration only. Different embodiments of an LL RDG window in a TXOP could be used without departing from the scope of this disclosure.

In the example of FIG. 13, the LL RDG window (which may also be referred to as an LL window of LL service period) within the TXOP emphasizes negotiations and protected durations to handle different access categories (ACs) and latency requirements. During the negotiation phase, a QoS element, buffer status, etc., can be exchanged in the next TXOP. The duration for AC_VI in the TXOP is T, a protected portion of the TXOP is allocated for AC_VO, e.g., tₗ. When there is a need of LL from the RD responder, the time it may utilize is tₗ.

In some embodiments, the RDG window can be determined dynamically based on the real time queue length, and the remaining time of the AC_VI in the TXOP.

Although FIG. 13 illustrates one example 1300 of an LL RDG window in a TXOP, various changes may be made to FIG. 13. For example, various changes to durations, etc. could be made according to particular needs.

As described herein, an LL RDG window refers to a duration which is embedded in a transmission such as pre-802.11bn RDG or TXOP or target wake time (TWT), etc. The LL RDG window may have a starting time, or an ending time, or a medium time, and channel utilization requirement during that duration. The information items of Table 5 may be provided for the LL RDG window during the negotiation phase or in an indication frame.

TABLE 5
LL RDG window

| Information items | Description |
|---|---|
| Start time | Indicates the start time of the RDG LL |
| | window. |
| End time | Indicates the end time of the RDG LL |
| | window. |
| Medium time | Indicates the medium time or average |
| | time of the RDG LL window. |
| Channel utilization | Indicates the available channel during the |
| | RDG LL window. |

In some embodiments, an LL RDG window may be started by transmitting a control frame such as an MU-RTS after receiving an indication or request from an RD responder or a TX responder. In embodiments, such as these, the LL RDG window information maybe indicated in the control frame. In some other embodiments, an LL RDG window may be started by transmitting any existing RDG frame or data with the information listed in Table 5.

In some embodiments, an RD responder may indicate that it has LLT by including an LL indication with urgency information in a block acknowledgement (BA) frame. In embodiments such as these the RD initiator may start the LL RDG after sending other PPDUs, but before reaching the delay bound for the LLT, such as shown in FIG. 14.

FIG. 14 illustrates an example 1400 of an RDG according to embodiments of the present disclosure. The embodiment of an RDG of FIG. 14 is for illustration only. Different embodiments of an RDG could be used without departing from the scope of this disclosure.

In the example of FIG. 14, STA1 is an RD initiator, and STA2 is an RD responder. Beginning from the left of FIG. 14, STA1 sends data packets with RDG=0, implying that STA2 cannot transmit any data packet yet. STA2 transmits an LLT indication containing urgency information in a BA frame, requesting a LL RD grant sooner. STA1 receives the BA and decides to send one more packet with RDG=0. STA1 decides to grant the TXOP to STA2 with RDG=1 since the RD responder's delay bound is approaching. STA2 transmits a BA with a request to transmit additional LL data (More PPDU=1). Depending on RDG=1 condition from STA1, STA2 transmits its LL data, and depending on RDG=1 condition from STA1, STA2 may transmit the additional LL data.

Although FIG. 14 illustrates one example 1400 of an RDG, various changes may be made to FIG. 14. For example, various changes to transmission times, the delay bound, etc. could be made according to particular needs.

In some embodiment, an LL window may be negotiated between the TXOP holder and responder. For example, the buffer state report, the QoS request and response, the LL session setup may be used to configure an RDG window.

In some embodiments, an RDG window may be initiated by the TXOP holder. In some other embodiments, the RDG window may be requested by the TXOP responder. In some other embodiments, the RDG window may be advertised by the AP in the EDCA parameters or beacons.

In some embodiments, an RDG may be dynamically assigned. For example, in some embodiments, the RDG may be dynamically assigned based on queue status, latency constraints, and QoS requirements at the RD responder and RD initiator.

In some embodiments, at the beginning of an RDG, a low latency indication (LLI) may include some particular low latency information, and a buffer report or SCS negotiation with some detailed low latency requirements may have been exchanged before the RDG. In embodiments such as these, the low latency information (e.g., queue information, latency constraints, medium time, timing info, etc.) could be exchanged in a buffer report with QoS characteristics. In some embodiments the LLI may provide an indication (e.g., a bit=1) for updated latency requirements, or the LLI may provide some updates on the latency requirements if needed.

In some embodiments, a negotiation mechanism between the RD responder and initiator can optimize RDG usage for real-time and low latency applications. For example, the RDG may be configured based on a buffer status request and report, QoS request and response, etc.

In some embodiments, a PPDU transmitted during an RDG may include an indication (e.g., a bit set to 1) “more PPDU” based on data sizes and urgency, which may be used to provide minimal channel underutilization.

In some embodiments, the RD responder may indicate a long response burst. For example, the RD responder may suggest a long PPDU, or multiple PPDUs, or a long aggregated MAC service data unit (MSDU) or PPDU in the indication of the long response burst. In some embodiments, the indication of the long response burst may include a bit (e.g., set to one) to indicate five or more aggregated MSDU. In some embodiments, the indication of the long response burst may also suggest the length or duration of the long PPDU, or the number of aggregated MSDUs.

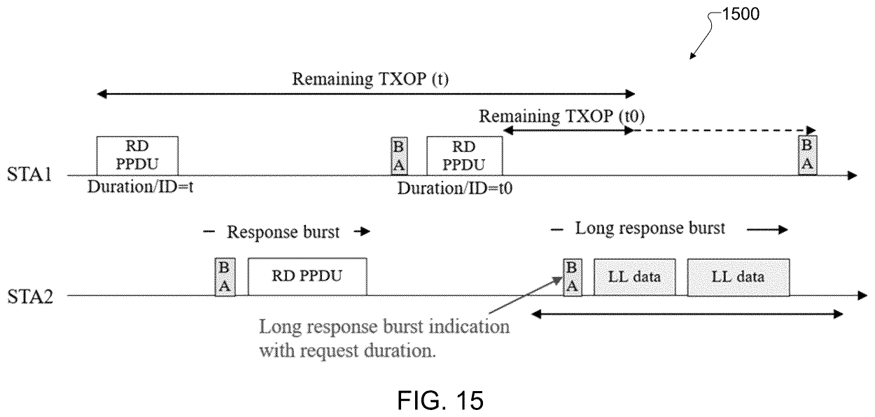

In some other embodiments, the RD responder may indicate a period of duration of the long LL PPDU or long response burst needs in the indication of the long response burst. For pre-802.11bn RDG protocol, the RD responder does not need to provide a duration or a time, though the RD responder may indicate a period of duration that it may need, if the duration is quite long or it may exceed the current TXOP. An example of a long response duration request is shown in FIG. 15.

FIG. 15 illustrates an example 1500 of an RD response request for a long response duration according to embodiments of the present disclosure. The embodiment of an RD response request for a long response duration of FIG. 15 is for illustration only. Different embodiments of an RD response request for a long response duration could be used without departing from the scope of this disclosure.

In the example of FIG. 15, STA1 starts an RD transmission including a suggestion the remaining time in Duration/ID=t. STA2 receives an RD PPDU with a Duration/ID=t0 which is less than the time that the STA2 may need, and STA2 sends a Long response burst indication in a control frame, and then continues the RD with the long response burst.

Although FIG. 15 illustrates one example 1500 of an RD response request for a long response duration, various changes may be made to FIG. 15. For example, various changes to bust indication, the number of frames in a burst, etc. could be made according to particular needs.

In some embodiments, the RD responder may not exceed the TXOP limit, but may exceed the current TXOP. In some other embodiments, other STAs that are associated with the RD initiator or TXOP holder may set the TXOP limit as the network allocation vector (NAV).

In some embodiments, a long response indication may be encoded in a control frame such as multi-STA BA. In some other embodiments, the information items listed in Table 6 may be encoded in the frame.

TABLE 6
Long response indication

| Information items | Description |
|---|---|
| Long response | If the LL response is long, for example, over |
| indication | five MSDUs are aggregated, or over 5 |
| | PPDUs will be transmitted, the long |
| | response indication is encoded as 1. |
| Overtime | If the LL response is long or it may exceed |
| requirement | the current TXOP, the overtime requirement |
| | is set to 1. |
| Additional time | If the overtime requirement is set to 1, the |
| request | RD responder may suggest the additional |
| | time it needs for the overtime requirement. |
| Medium time | The responder may have an estimated time |
| | such as the medium time when requesting |
| | any duration that may exceed the current |
| | TXOP. |

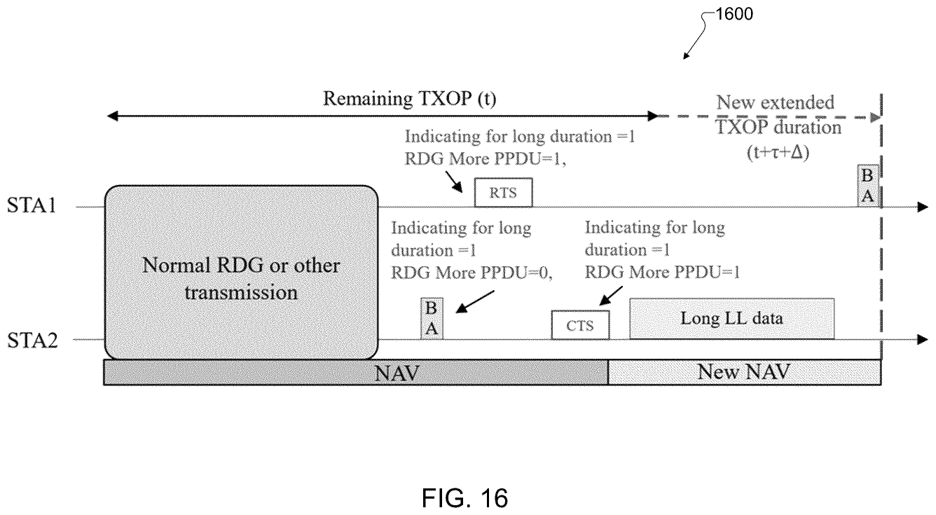

In some embodiments, the RD initiator may send another set of RTS and CTS frames before the end of the current TXOP. The RTS and CTS frames may set the requested duration which may be suggested by the RD responder in the control frame or acknowledgement. An example is shown in FIG. 16.

FIG. 16 illustrates an example 1600 of an RD responder request for a long response duration by RTS/CTS according to embodiments of the present disclosure. The embodiment of an RD responder request for a long response duration by RTS/CTS of FIG. 16 is for illustration only. Different embodiments of an RD responder request for a long response duration by RTS/CTS could be used without departing from the scope of this disclosure.

In the example of FIG. 16, STA1 and STA2 perform normal RDG or other transmission, after which STA2 transmits a request for a long response duration. In response, STA1 transmits an RTS that sets the long duration to 1 and RDG more PPDU to 1. STA2 responds with a CTS indicating long duration is set to 1 and RDG more PPDU is set to 1, and transmits a long duration LL data transmission.

Although FIG. 16 illustrates one example 1600 of an RD responder request for a long response duration by RTS/CTS, various changes may be made to FIG. 16. For example, various changes to the indication, the amount of data, etc. could be made according to particular needs.

In some embodiments, the RD initiator may ignore or reject the request for a long response duration if the requesting TXOP exceeds the TXOP limits. In some embodiments, the initiator may issue a longer period of time. In some embodiments, the initiator may issue a shorter time for the responder.

In some other embodiments, the RD initiator may trigger a high capability for the responder. In some embodiments, the RD initiator may allocate more frequency resource units to the responder.

In some embodiments, the RD responder may set RD More PPDU equal to zero while a bit indicating the long duration needs is set to one, and the RD initiator may send the RTS with RD More PPDU equal to 1.

In some embodiments, the RD responder may send the RTS with a new request duration, and after receiving the CTS, the RD initiator may send a trigger frame to request the PPDU from the receiver.

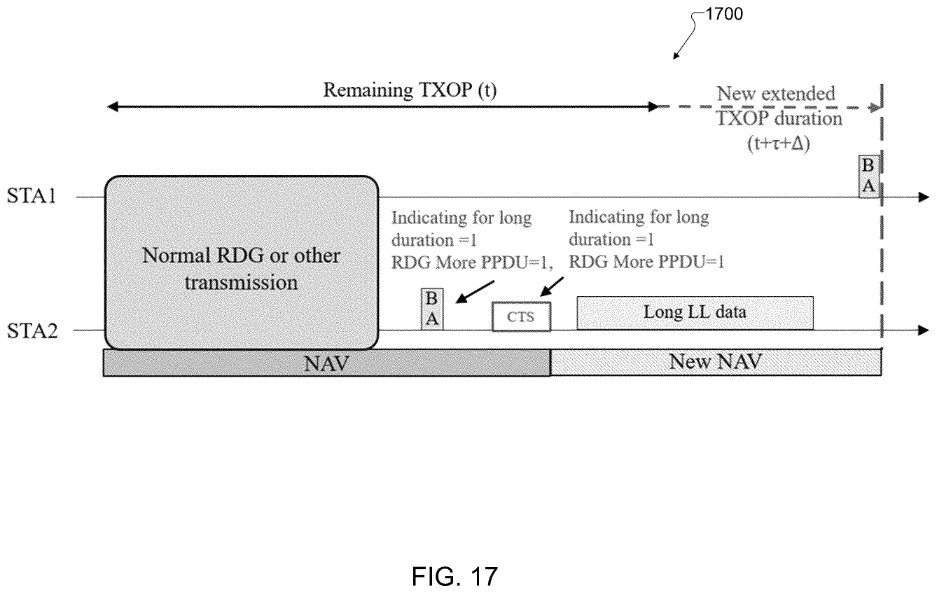

In some embodiments, the RD responder may send a CTS right after the indication of the exceeding duration. In embodiments such as these, the RD responder may set the RD More PPDU bit equal to one but sending the CTS after the BA to obtain a longer duration. An example is shown in FIG. 17.

FIG. 17 illustrates an example 1700 of an RD responder request for a long response duration by CTS according to embodiments of the present disclosure. The embodiment of an RD responder request for a long response duration by CTS of FIG. 17 is for illustration only. Different embodiments of an RD responder request for a long response duration by CTS could be used without departing from the scope of this disclosure.

In the example of FIG. 17, STA1 and STA2 perform normal RDG or other transmission, after which STA2 transmits a request for a long response duration. STA2 then immediately transmits a CTS indicating long duration is set to 1 and RDG more PPDU is set to 1, and transmits a long duration LL data transmission.

Although FIG. 17 illustrates one example 1700 of an RD responder request for a long response duration by CTS, various changes may be made to FIG. 17. For example, various changes to the indication, the amount of data, etc. could be made according to particular needs.

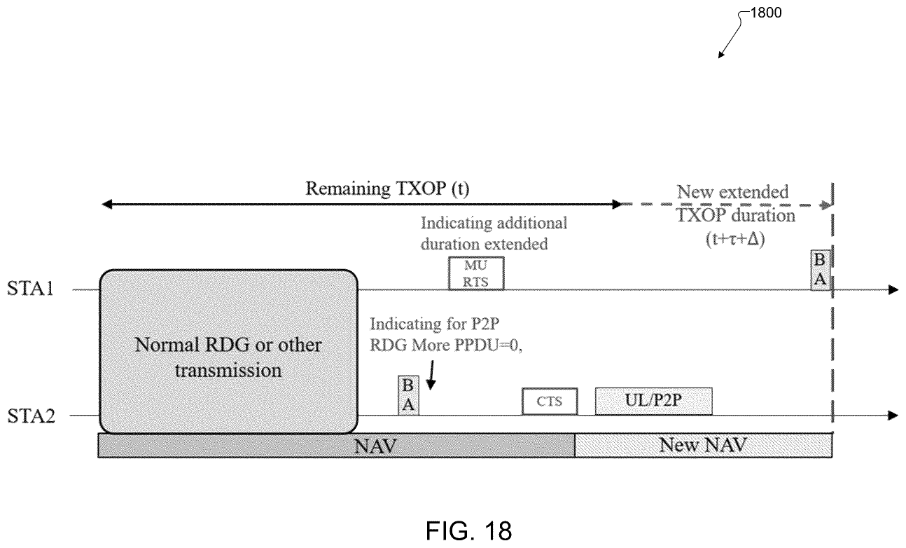

In some embodiments, the RD initiator may send an MU-RTS before the end of the current TXOP of the RDG. The MU-RTS and CTS may set the requested duration which may be suggested by the RD responder in the control frame or acknowledgement. An example is shown in FIG. 18.

FIG. 18 illustrates an example 1800 of an RD responder request for a long response duration by MU-RTS/CTS according to embodiments of the present disclosure. The embodiment of an RD responder request for a long response duration by MU-RTS/CTS of FIG. 18 is for illustration only. Different embodiments of an RD responder request for a long response duration by MU-RTS/CTS could be used without departing from the scope of this disclosure.

In the example of FIG. 18, STA1 and STA2 perform normal RDG or other transmission, after which STA2 transmits a request for a long response duration for P2P. In response, STA1 transmits an MU-RTS that sets the long duration 1. STA2 responds with a CTS, and transmits an UL/P2P data transmission.

Although FIG. 18 illustrates one example 1800 of an RD responder request for a long response duration by MU-RTS/CTS, various changes may be made to FIG. 18. For example, various changes to the indication, the amount of data, etc. could be made according to particular needs.

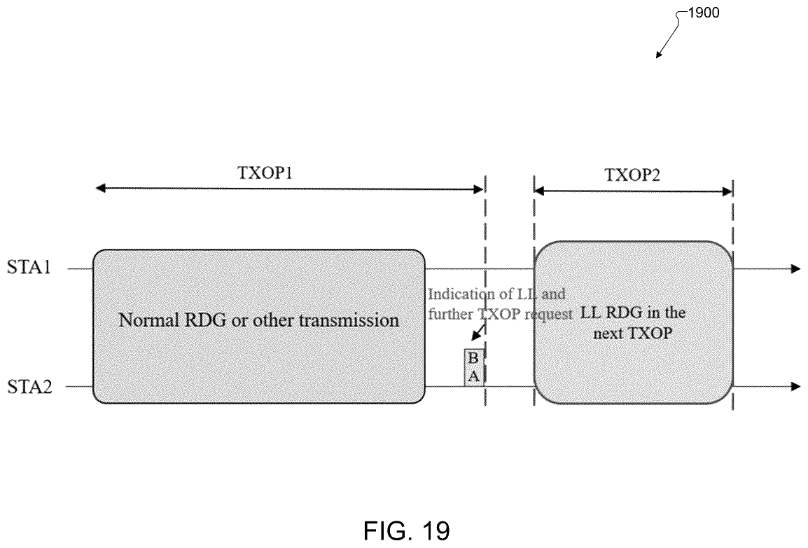

In some embodiments, the RD initiator or the TXOP holder or the AP may transmit the LL traffic in the next few TXOPs. The RD responder may request a further TXOP or LL RDG in the further TXOP. An example is shown in FIG. 19.

FIG. 19 illustrates an example 1900 of an RD responder request for a further TXOP for LL traffic according to embodiments of the present disclosure. The embodiment of an RD responder request for a further TXOP for LL traffic of FIG. 19 is for illustration only. Different embodiments of an RD responder request for a further TXOP for LL traffic could be used without departing from the scope of this disclosure.

In the example of FIG. 18, STA1 and STA2 perform normal RDG or other transmission, after which STA2 transmits an LLI that includes a request for a further TXOP. In the next TXOP, STA and STA perform LL RDG.

In some embodiments, the further request TXOP, (i.e., TXOP2), can be obtained using EDCA or Hip EDCA. In some embodiments, the further request TXOP may also be obtained by a contention-free mechanism, such as hybrid coordination function (HCF) controlled channel access (HCCA) from the AP or the TXOP holder.

Although FIG. 19 illustrates one example 1900 of an RD responder request for a further TXOP for LL traffic, various changes may be made to FIG. 19. For example, various changes to indication could be made, etc. according to particular needs.

In some embodiments, the RD initiator or the TXOP holder or the AP may transmit an initial control frame (ICF) in the beginning of the TXOP requesting the LLT.

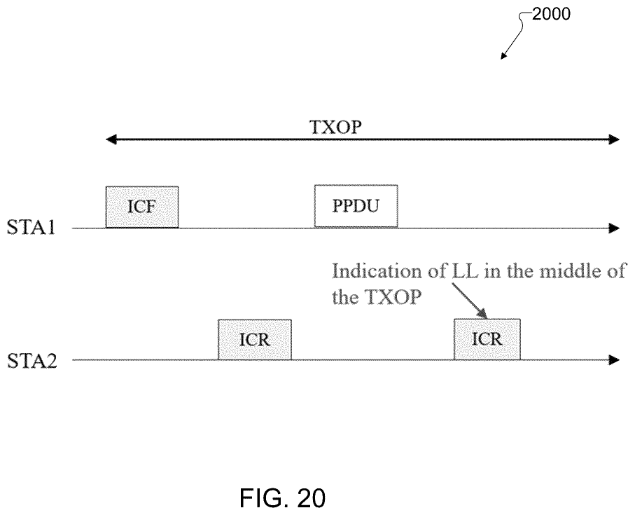

In some embodiments, the RD responder may transmit an initial control response frame (ICR) indicating that LL traffic may arrive during the TXOP sometime in the beginning of the TXOP. An example is shown in FIG. 20.

FIG. 20 illustrates an example 2000 of indicating LL in the middle of a TXOP according to embodiments of the present disclosure. The embodiment of indicating LL in the middle of a TXOP of FIG. 20 is for illustration only. Different embodiments of indicating LL in the middle of a TXOP could be used without departing from the scope of this disclosure.

In the example of FIG. 20, during a TXOP, STA1 transmits an ICF. In response STA2 transmits an ICR. STA1 transmits a PPDU, and while still in the TXOP, STA2 transmits an ICR indicating LL.

Although FIG. 20 illustrates one example 2000 of indicating LL in the middle of a TXOP, various changes may be made to FIG. 20. For example, various changes to indication could be made, etc. according to particular needs.

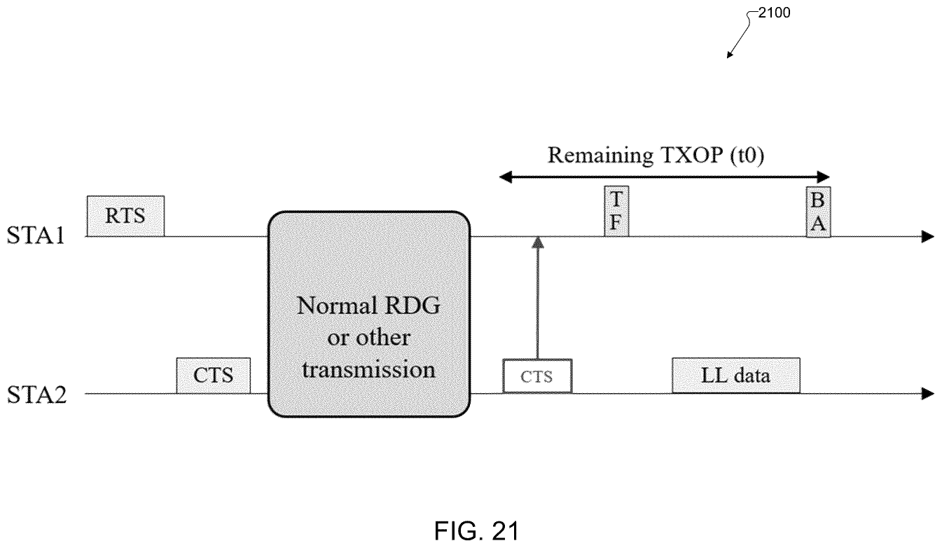

In some embodiments, when the LLT arrives in the middle of the TXOP, the responder may transmit an ICR with the LL indication. The ICR may include a CTS frame, RTS frame, etc. In some embodiments, the LL indication may embed in the CTS frame, and the RD initiator or the TXOP holder may trigger the LL STA after receiving the CTS with the LL indication as shown in FIG. 21.

FIG. 21 illustrates an example 2100 of indicating LL by embedment in a CTS frame in the middle of a TXOP according to embodiments of the present disclosure. The embodiment of indicating LL by embedment in a CTS frame in the middle of a TXOP of FIG. 21 is for illustration only. Different embodiments of indicating LL by embedment in a CTS frame in the middle of a TXOP could be used without departing from the scope of this disclosure.

In the example of FIG. 21, during a TXOP, STA1 transmits an ICF (i.e., RTS). In response STA2 transmits an ICR (i.e., CTS). STA1 and STA2 perform normal RDG or other transmission, after which STA2 transmits a CTS with an embedded LL indication. In response to the LLI, STA1 transmits a trigger frame, and STA2 transmits its LL data within the remainder of the TXOP.

Although FIG. 21 illustrates one example 2100 of indicating LL by embedment in a CTS frame in the middle of a TXOP, various changes may be made to FIG. 21. For example, various changes to indication could be made, etc. according to particular needs.

In some embodiments, signaling LL by embedment in a CTS may be as shown in Table 7.

TABLE 7
CTS with LL indication

| | | | | |
|---|---|---|---|---|
| Frame Control | Duration | RA | LL information | FCS |

In Table 7, the LL information field may include TID, SCS ID, AC, urgency information such as enqueue time, expiration time, remaining time to expiration, delay bound, etc.

In some embodiments, the RD responder may indicate one or more of the following policy actions (desires or requests) to the RD initiator:
1. Low latency traffic needs or UL traffic request. For example, in some embodiments, the responder may indicate that it has traffic requiring immediate or time-sensitive transmission, e.g., AC_VO or AC_VI. In some embodiments, the responder may indicate the request of a LL DL PPDU from the initiator (e.g., in the P2P case, the RD responder may indicate a desire or a trigger to request the LL from the initiator peer STA).
2. Request for TXOP sharing. The responder may request the initiator to allocate a portion of the remaining TXOP for its transmission. The responder may return the TXOP before the given time.
3. Request for TXOP termination. The responder may indicate a desire to end the current TXOP and relinquish channel control to the responder.
4. P2P communication request. The responder may indicate a desire to start a P2P session between the responder and another STA.
5. UL and P2P communication request. The responder may indicate a desire to either perform an UL or P2P transmission.
6. Coexistence event notification. The responder may notify the initiator about a co-ex event.
7. Request for a role switch, ask the initiator to temporarily transfer TXOP control to the responder, enabling it to manage channel access for a period.
8. Emergency transmission request. A critical, high priority request for immediate access to the channel due to urgent traffic or system requirements.

In some embodiments, one of the above policy actions may be indicated in a subfield of a RD responder field. In some other embodiments, one of the above policy actions may be indicated in a subfield of an UHR RD field.

In some embodiments, an UHR STA with enhanced RD procedure capabilities may set one or all of the RD responder Mode 1 Support subfield, the RD responder Mode 2 Support subfield, and the Mode M Support subfield in the UHR Capabilities element to 1.

If the UHR RD responder determines that its transmission of an LL indication to an RD initiator with the policy action equal to 1 is successful, then the RD responder may transmit a control frame indicating a buffered low latency traffic addressed to the RD initiator.

If the UHR RD responder determines that its transmission of an LL indication to a RD initiator with the policy action equals to 2 is successful, then the RD responder may transmit a control frame indicating a buffered low latency traffic addressed to the RD initiator and to another STA by a scheduled STA within a requested or allocated time.

Similarly, If the UHR RD responder determines that its transmission of an LL indication to a RD initiator with the policy action equal to M is successful, then the RD responder may transmit a control frame indicating a buffered low latency traffic or action suggested in the above policy actions.

In some embodiments, the RD initiator may perform one of the following policy actions:
1. The RD initiator may grant or share the TXOP. In some embodiments, the initiator may grant the TXOP in the next PPDU after an LL indication in a BA or MBA is detected. In some other embodiments, the RD initiator may send an ICF and grant or share the TXOP in the next few PPDUs. In some other embodiments, an LL service period may be granted to the responder. The initiator may allocate a portion of the remaining TXOP to the RD responder, creating an LL RDG window, for example, the RD responder may transmit an MU-RTS frame. This allocation can be static, a pre-determined duration based on the responder's request, or a dynamic allocation which is adjusted based on real-time traffic demands.
2. Terminate the TXOP. The initiator may decide to terminate the current TXOP (e.g., CF-end), and relinquish control of the channel, allowing the responder to access the channel via contention-based mechanisms.
3. Queue the request. The initiator acknowledges the LL request but postpones its fulfillment until a specific traffic or time is scheduled or arrived, depending on the initiator's own traffic demands, or another RDG responder's request during the TXOP. For example, the initiator may also send an ICF and start from the next PPDU.
4. Schedule in the next TXOPs. The initiator defers the responder's LL request to the next TOXP or Hip EDCA and adjusts scheduling to prioritize the responder's traffic in the future.
5. Reject the LL request. The initiator explicitly rejects the request if the initiator deems it infeasible to accommodate the responder's LL need within the current TXOP.
6. Modify or update some existing RDG or LL parameters. The initiator adjusts the parameters, (e.g., duration, priority for ongoing and future transmissions) to better accommodate the LL request.
7. Extend TXOP duration. If allowed by the medium access policy, the initiator may extend the TXOP duration to accommodate both the LL request and its own ongoing transmissions.
8. Dynamically split the remaining TXOP between the initiator and responder. Both parties take turns transmitting traffic until the TXOP expires.
9. Initiate role switch. The initiator temporarily hands over TXOP control to the responder, enabling it to manage traffic or coordinate with other STAs.
10. Trigger coexistence mechanism. In response to a co-ex event notification, the initiator may pause its ongoing transmission, allocate resources for the coex event, (e.g., Bluetooth or zigbee), and end the TXOP or not disturb the responder.

In some embodiments, the RD initiator may indicate its subsequent policy action for RDG in a negotiation procedure or other procedures such as broadcast, beacon, probe, association, reassociation, authentication, etc. In some embodiments, the above policy actions may be indicated in a subfield of an RD initiator field.

In some embodiments, the RD initiator and the RD responder may include a negotiation procedure for either RD procedure or preemption. The above policy actions may be negotiated as long term or short term, dynamic or static.

In some embodiments, the negotiation procedure may include the actions agreement and code. The RD initiator may indicate in its action policy to the RD responder when the RD responder may send the LL traffic. For example, the RD initiator may suggest to apply MU-RTS TXS for P2P requests if the RD responder requests any P2P or uplink activities.

In general, the RD responder sends a request or desire (e.g., TXOP sharing, P2P session, role switch, coex event).

The RD initiator may choose an appropriate action which may include granting a RD (window), sharing or terminating the TXOP, deferring the request, or rejecting the request.

In some embodiments, the RD responder may send a “Retry request” to an RD initiator if acknowledgements fail within the RDG TXOP.

In some embodiments, a recovery mechanism may be used if a LL RDG transmission fails. For example, missed frames with high priority may be retransmitted in subsequent TXOPs. In some other embodiments, future LL RDG window allocations may be adjusted based on historical errors.

As noted above, various embodiments of the present disclosure provide mechanisms for low latency setup and negotiation.

In some embodiments, UHR STAs that participate in preemption may register membership with a UHR AP to gain awareness of whether a TXOP is preemptable.

In some embodiments, if one TXOP allows preemption, an LL STA may stay awake during the whole TXOP. In some embodiments, the TXOP does not allow preemption or the TXOP is a legacy STA's TXOP, the LL STA may choose to enter a doze state.

In some embodiments, a membership registration session with a UHR AP may include a preemption power saving mode (PSM) request and response.

In some embodiments, a UHR STA who has LLT may indicate a desire for preemption, for example, by registering with a UHR AP. In these embodiments, the AP may then broadcast information regarding the registration. In some embodiments, when an LL STA may preempt a TXOP holder which is a non-AP STA, the LL STA may indicate the desire for preemption before each TXOP in the beacon, probe request frame or other frames or elements such as TDLS response frame, ANQP request, etc.

In some embodiments, a UHR STA that supports preemption may indicate the capability of preemption. Thus, when these STAs win a TXOP, they may support preemption during the TXOP.

In some embodiments, for an upcoming TXOP, an indication of whether the TXOP is preemptable can be embedded into frames such as RTS, MU-RTS, etc.

In some embodiments, a UHR STA may facilitate TWT level preemption by indicating in a TWT request and response frame that a TWT service period (SP) can be preempted.

In some embodiments, one or more LL STAs may start a membership session with a TXOP holder. For example, a 3rd party may preempt a non-AP STA who is the TXOP holder and send LLT to either the AP or the TXOP holder. In such embodiments, the AP may or may not have a registered membership with this 3rd party STA.

In some embodiments, a non-AP STA that is a TXOP holder may share a registered membership list with AP.

In some embodiments, an AP may share with a TXOP holder a registered membership list. In embodiments such as these, when the TXOP holder is a non-AP STA, the non-AP STA may be aware of which STAs are allowed to preempt or transmit the LLT.

In some embodiments, preemption occurs in one BSS, and an LL STA may request to establish a LL preemption session within the BSS. In examples such as these, the preemption session may include LL RDG, low latency indication, and general preemption use cases.

In some embodiments, the session initiator may be the preempting LL STA. In some embodiments, where the TXOP holder or TWT responder is an AP, the preempting LL STA register with the AP before initiating preemption.

In some embodiments, the preempting STA can be a non-AP STA, and the TXOP holder or TWT responder may be any of an AP, a TWT responding STA, a TXOP responder, a third-party STA with no roles other than an LL STA, etc. In some embodiments, the session initiator may also be a preempted STA, and the preempted STA may offer a preemption opportunity to STAs which associated with or unassociated with the preempted STA.

In some embodiments, the session responder can be the AP as a TXOP holder, a TXOP holder, a TWT requesting STA, etc.

In some embodiments, before a preemption, the session initiator and session responder may both agree to enable preemption. An example is shown in 2200.

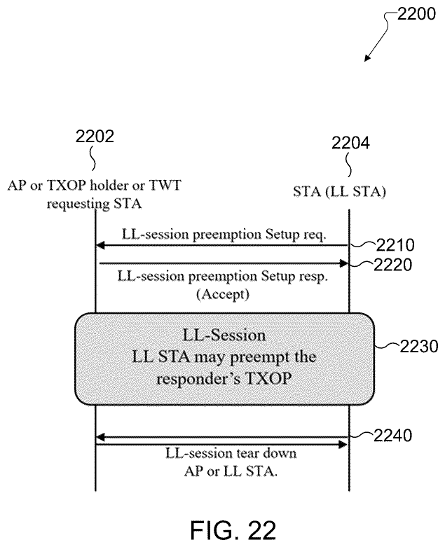

FIG. 22 illustrates an example method 2200 for LL-session setup between two STAs according to embodiments of the present disclosure. An embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a method for LL-session setup between two STAs could be used without departing from the scope of this disclosure.

In the example of FIG. 22, method 2200 is performed between a first electronic device 2202 (which may be an AP, a TXOP holder, or a TWT requesting STA) and a second electronic device 2204 (which is an LL STA).

Method 2200 begins at step 2210. At step 2210, device 2204 requests preemption by sending a LL-session preemption Setup request frame to device 2202.

At step 2220, device 2202 may respond with an LL-session preemption Setup response frame with an accept or reject code depending on the settings and capabilities.

Information items included in the setup request frames may include category, dialog token, and preemption, as shown in Table 8.

TABLE 8
Information items in preemption setup frame action field format

| Order | Definition |
|---|---|
| 1 | category |
| 2 | Dialog Token |
| 3 | Preemption |

In a preemption setup frame with a preemption request field that is equal to 1, the Dialog Token field is set to a value chosen by the by the transmitting STA to identify the request/response transaction. In a preemption Setup frame with a Preemption Request field equal to 0, the Dialog Token field is set to the value copied from the corresponding received Preemption Setup frame with a Preemption Request field equal to 1.

The preemption field may include Preemption Action, preemption capability, Qos capability, Link identifier, etc., as shown in Table 9.

TABLE 9
Information items in Preemption subfield
of preemption setup frame action field

| Order | Definition |
|---|---|
| 1 | Preemption Action |
| 2 | preemption capability |
| 3 | QoS capability |
| 4 | Link identifier |

The preemption Action may include preemption Setup request, Setup response, Teardown, Channel Switch request, Channel Switch response, Preemption PSM request, Preemption PSM response, and reserved as shown in Table 10. The fields can be reused or borrowed from existing frames such as TWT setup or TDLS setup frames.

TABLE 10
Information items in Preemption Action field

| Order | Definition |
|---|---|
| 1 | preemption Setup request |
| 2 | preemption Setup response |
| 3 | preemption teardown |
| 4 | Channel Switch request |
| 5 | Channel Switch response |
| 6 | Preemption PSM request |
| 7 | Preemption PSM response |

At step 2230, an LL-session between device 2202 and device 2204 begins, and device 2204 may preempt a TXOP held by device 2202.

At step 2240, the LL-session is ended, and an LL-session tear down is performed between device 2202 and device 2204.

Although FIG. 22 illustrates one example method 2200 for LL-session setup between two STAs, various changes may be made to FIG. 22. For example, while shown as a series of steps, various steps in FIG. 22 could overlap, occur in parallel, occur in a different order, occur any number of times, be omitted, or replaced by other steps.

In some embodiments, where a TXOP holder or TWT responder is a non-AP STA, the LL STA may inform the transmission pair know before the LL session starts (e.g., the LL STA will inform both the AP and TXOP holder [non-AP STA] or TWT responder know). The LL STA may also indicate to the AP and relay on the AP to notify the other peer STA, for example in a third-party preemption case, (e.g., case 2, 3, and case 8, 9 in Table 2).

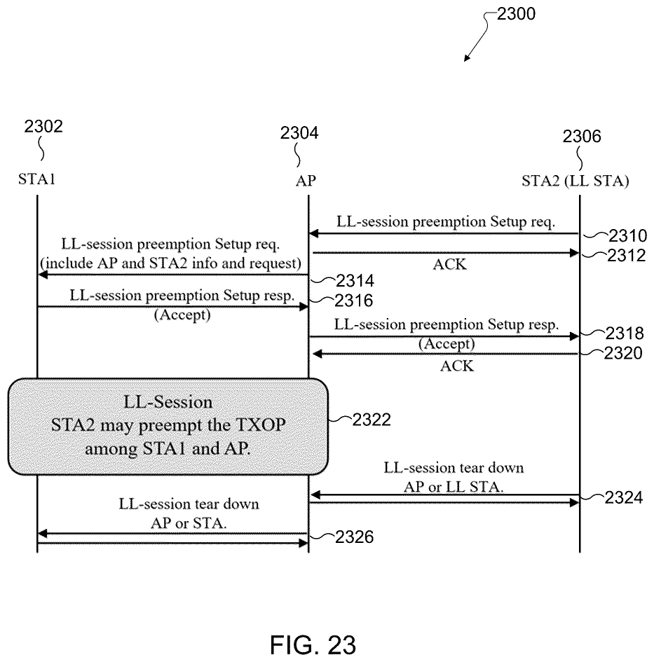

In some embodiments, the LL STA or the third-party preemptor may first send an LL-session preemption setup request frame to an AP, and either the TXOP holder or responder before the transmission. Then the AP may then notify other STAs about the request. The AP may then confirm the request with the peer STA(s) and provide an acceptance notification to the LL STA. An example is shown in FIG. 23.

FIG. 23 illustrates an example method 2300 for LL-session setup between three STAs according to embodiments of the present disclosure. An embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a method for LL-session setup between three STAs could be used without departing from the scope of this disclosure.

In the example of FIG. 23, method 2300 is performed between a first electronic device 2302 (STA1) a second electronic device 2304 (AP), and a third electronic device 2306 (STA2, which is an LL STA).

Method 2300 begins at step 2310. At step 2310, device 2306 requests preemption by sending an LL-session preemption Setup request frame to device 2304. Device 2304 replies with an acknowledgment at step 2312.

At step 2314, device 2304 forwards the LL-session Setup request frame to device 2302, including device 2304 and 2306's information.

At step 2316, device 2302 may respond with an LL-session preemption Setup response frame with an Accept or reject code depending on the settings and capabilities.

At step 2318, device 2304 forwards the LL-session preemption Setup response frame to device 2306. Device 2306 replies with an acknowledgment at step 2320.

At step 2322, an LL-session between devices 2302, 2304, and 2306 begins, and device 2206 may preempt a TXOP held by device 2302 or 2304.

At step 2324, the LL-session is ended, and an LL-session tear down is performed between device 22306 and device 2304.

At step 2326, an LL-session tear down is performed between device 22302 and device 2304.

In method 2300, the LL-session preemption setup request and response frames may be similar as described regarding method 2200. Additionally, the user info field may include the participating STAs, (e.g., the AP may provide the AP and STA2's info to STA1 with the request for the LL-session setup).

Although FIG. 23 illustrates one example method 2300 for LL-session setup between three STAs, various changes may be made to FIG. 23. For example, while shown as a series of steps, various steps in FIG. 23 could overlap, occur in parallel, occur in a different order, occur any number of times, be omitted, or replaced by other steps.

In some embodiments, the LL STA may also perform a set up with each STA in the transmission pair (e.g., with the TXOP holder and TXOP responder respectively). This may be similar as described regarding method 2200.

As noted above, various embodiments of the present disclosure provide mechanisms to keep devices awake to receive LLT traffic.

In some embodiments, an LL STA in power save mode may enter a doze state when it has successfully transmitted to and received from the TXOP holder or TXOP responder within a preemptable TXOP.

An LL STA preempting the TXOP may optionally set the More Data subfield to 1 in Ack frames to a receiver STA that has PSM enabled and that has the More Data Ack subfield set to 1 in the QoS Capability element of its transmitted LL Setup Request frame or Setup Response frame to indicate that it has a pending transmission for the STA.

In some embodiments, to keep track of the preemption session and to maintain the wakeup schedule, an LL STA may start an acknowledged frame exchange at least once per Idle Count consecutive LL session time window, as a keepalive.

In some embodiments, a static preemption power saving mode (PSM) may be employed. In these embodiments, the LL STAs may remain in awake mode during the entirety of a preemptable TXOP.

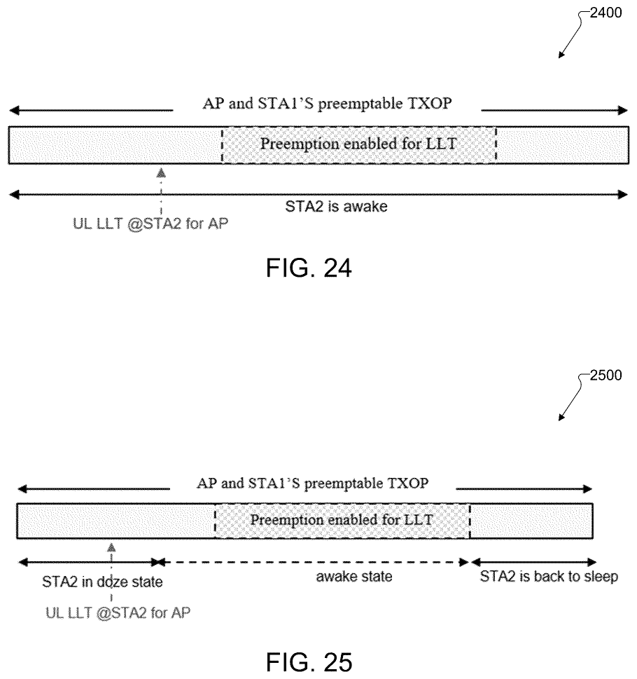

In some embodiments, when a preemptable TXOP begins, preemption is activated within the TXOP. For example, if dot11PreemptionServiceActivated is true, and If_preemptable_TXOP is true, a STA with LLT or registered UHR STAs or a STA registered to the preemption services may stay awake during the preemptable TXOP. An example is shown in FIG. 24

FIG. 24 illustrates an example 2400 of a STA staying awake during a whole preemptable TXOP according to embodiments of the present disclosure. The embodiment of a STA staying awake during a whole preemptable TXOP of FIG. 24 is for illustration only. Different embodiments of a STA staying awake during a whole preemptable TXOP could be used without departing from the scope of this disclosure.

In the example of FIG. 24, STA2 is awake during the entirety of a preemptable TXOP held by the AP or STA1. STA 2 has UL LLT for the AP, and may transmit the UL LLT to the AP during a preemption window.

Although FIG. 24 illustrates one example 2400 of a STA staying awake during a whole preemptable TXOP, various changes may be made to FIG. 24. For example, various changes to preemption duration, etc. could be made according to particular needs.

In some embodiments, an indication of a preemptable TXOP or preemption service period (SP) is provided. For example, an LL STA may detect the header of the trigger frames (e.g., in RTS, MU-RTS, etc.), for the preemption indication.

In some embodiments, a preemption PSM frame may be exchanged during or after an LL-session setup. The preemption PSM frame may include an Awake Window slot, maximum awake window duration, Idle count, etc. as shown in Table 11.

TABLE 11
Subfield in PSM frame

| | | |
|---|---|---|
| Awake Window slots | Maximum Awake Window Duration | Idle Count |

In some embodiments, the fields of a preemption PSM frame may be used to set the Awake Window slot as the TXOP limit. Maximum Awake Window Duration may be the time in microseconds of the NAV in the Duration field of the RTS frame if the time is greater than the TXOP limit.

In some embodiment, a dynamic preemption power saving mode (PSM) may be used, where the LL STAs can be in awake mode and doze state during the preemptable TXOP.

For STAs which may transmit LLT, when the STAs listen for the indication of the current TXOP which is preemptable TXOP, the STAs will still sleep until they LLT to preempt, and after the transmission, the STAs can return to sleep mode. as shown in FIG. 25. This may result in a loss of the LLT from the TXOP holder or TXOP responder, but could save power compared to listening to the whole TXOP.

FIG. 25 illustrates an example 2500 of dynamic PSM where a STA is awake when LLT arrives according to embodiments of the present disclosure. The embodiment of PSM of FIG. 25 is for illustration only. Different embodiments of dynamic PSM where a STA is awake when LLT arrives could be used without departing from the scope of this disclosure.

In the example of FIG. 24, STA2 is awake during the portion of a preemptable TXOP held by the AP or STA1 when preemption is enabled. STA 2 has UL LLT for the AP, but is asleep and does not transmit the UL LLT to the AP.

Although FIG. 25 illustrates one example 2500 of dynamic PSM where a STA is awake when LLT arrives, various changes may be made to FIG. 25. For example, various changes to preemption durations, etc. could be made according to particular needs.

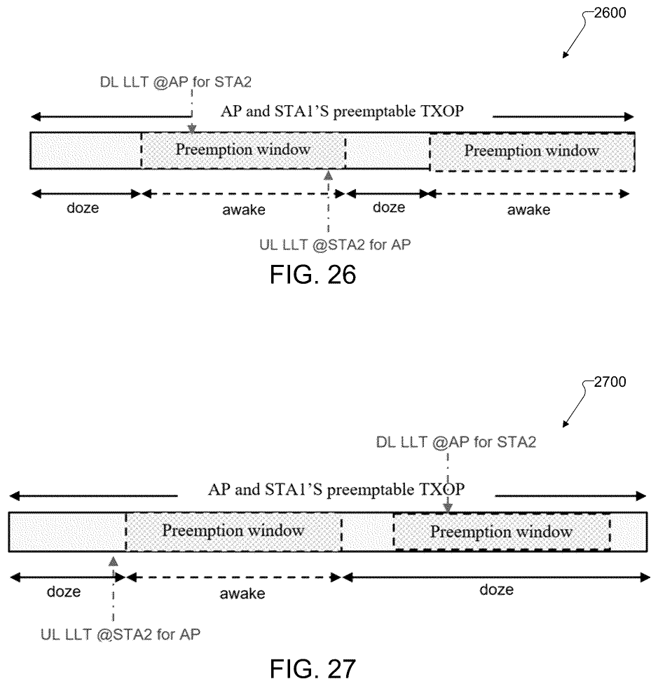

In some embodiments, for STAs which may transmit LLT, when the STAs listen for an indication of the current TXOP which is preemptable TXOP, the STAs will still sleep until the preemption window starts or initiates, and after the transmission in the preemption window, the STAs can go back to sleep mode either until the next preemption window or next TXOP. An example is shown in FIG. 26.

FIG. 26 illustrates an example 2600 of dynamic PSM where a STA is awake when preemption windows activate according to embodiments of the present disclosure. The embodiment of PSM of FIG. 26 is for illustration only. Different embodiments of dynamic PSM where a STA is awake when preemption windows activate could be used without departing from the scope of this disclosure.

In the example of FIG. 26, STA2 is asleep during a preemptable TXOP held by the AP or STA1 except during preemption windows. The AP has DL LLT for STA2, and may transmit the DL LLT to STA2 during the preemption window. STA 2 has UL LLT for the AP, and may transmit the UL LLT to the AP during the preemption window. Because the LLT is received during the preemption window, STA2 is awake to exchange the LLT.

Although FIG. 26 illustrates one example 2600 of dynamic PSM where a STA is awake when preemption windows activate, various changes may be made to FIG. 26. For example, various changes to preemption durations, etc. could be made according to particular needs.

In some embodiments, to avoid multiple transitions from doze to awake to doze states, a STA may wake up once in one or a fixed number of preemption windows in one TXOP. An example is shown in FIG. 27

FIG. 27 illustrates an example 2700 of dynamic PSM where a STA is awake when preemption windows activate with constraints according to embodiments of the present disclosure. The embodiment of PSM of FIG. 27 is for illustration only. Different embodiments of dynamic PSM where a STA is awake when preemption windows activate with constraints could be used without departing from the scope of this disclosure.

In the example of FIG. 27, STA2 is asleep during a preemptable TXOP held by the AP or STA1 except during the first preemption window. STA 2 has UL LLT for the AP, and the AP has DL LLT for STA2. Because the LLT is received when STA2 is asleep, STA2 is unavailable to exchange the LLT.

Although FIG. 27 illustrates one example 2700 of dynamic PSM where a STA is awake when preemption windows activate with constraints, various changes may be made to FIG. 27. For example, various changes to preemption durations, etc. could be made according to particular needs.

In some embodiments, a TDLS PSM frame in one TXOP duration period may be modified as preemption PSM frame, shown in Table 12.

TABLE 12
Subfield in preemption PSM frame.

| | | |
|---|---|---|
| Interval | Awake Preemption | Maximum Awake Preemption |
| | Window slots | Window Duration |

The interval field denotes the time in microseconds between the start of two successive Awake Preemption Windows in one TXOP.

The Awake Window Slot denotes the duration of the Awake Preemption Window

The Maximum Awake Window Duration field denotes the maximum duration of the Awake Preemption Window.

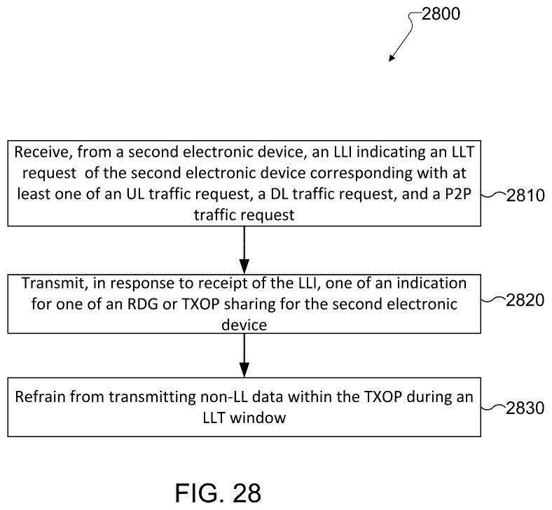

FIG. 28 illustrates an example method 2800 for resource management preemption according to embodiments of the present disclosure. An embodiment of the method illustrated in FIG. 28 is for illustration only. One or more of the components illustrated in FIG. 28 may be implemented in specialized circuitry configured to perform the noted functions or one or more of the components may be implemented by one or more processors executing instructions to perform the noted functions. Other embodiments of a method for resource management preemption could be used without departing from the scope of this disclosure.

In the example of FIG. 28, method 2800 is performed by a first electronic device (for example, STA1 of FIG. 14) during a TXOP of the first electronic device. Method 2800 begins at step 2810. At step 2810, the first electronic device receives, from a second electronic device (such as STA2 of FIG. 14), an LLI indicating an LLT request of the second electronic device. The LLT request includes at least one of an UL traffic request, a DL traffic request, and a P2P traffic request.

At step 2820, in response to receipt of the LLI, the first electronic device transmits an indication for one of an RDG or TXOP sharing for the second electronic device.

In some embodiments, the LLI may include urgency information, and the first electronic device may determine an expiration time based on the urgency information included in the LLI. In these embodiments, the first electronic device may perform a policy action (such as transmitting the indication for one of an RDG or TXOP sharing for the second electronic device at a determined time before the expiration time).

At step 2830, the first electronic device refrains from transmitting non-LL data within the TXOP during an LLT window. The LLT window is a duration within the TXOP corresponding with the RDG or TXOP sharing in which the second electronic device may exchange the LLT or P2P traffic.

In some embodiments, where the LLI includes a LLT request, the first electronic device may determine a policy action based on the LLT request included in the LLI, and may perform the policy action.

In some embodiments, where the LLI includes a P2P request, the first electronic device may determine a policy action based on the P2P request included in the LLI, and may perform the policy action.

In some embodiments, the LLI and LLT window may be determined based on a negotiation between the first electronic device and the second electronic device. In some embodiments, the first electronic device may determine the LLT window based on at least one of a queue status, a latency constraint, and a QoS requirement.

In some embodiments, the LLI may include an indication of a long LLT, and the first electronic device may determine the LLT window based on the indication of the long LLT.

In some embodiments, the LLI may include a request for additional time or an additional TXOP, and the first electronic device may, during a later TXOP held by the first electronic device, transmit an additional time for LLT indication for the second electronic device.

In some embodiments, prior to the TXOP held by the first electronic device, the first electronic device may receive, from the second electronic device, a setup request, and transmit, to the second electronic device, a setup response indicating acceptance of an LL session.

In some embodiments, after the TXOP held by the first electronic device, the first electronic device may receive, from the second electronic device, a teardown request, and transmit, to the second electronic device, a teardown response indicating teardown of the LL session.

In some embodiments, prior to the TXOP held by the first electronic device, the first electronic device may receive, from a third electronic device, a setup request for the second electronic device, and transmit, to the third electronic device, a setup response indicating acceptance of an LL session.

In some embodiments, after the TXOP held by the first electronic device, the first electronic device may receive, from the third electronic device, a teardown request for the second electronic device, and transmit, to the third electronic device, a teardown response indicating teardown of the LL session.

Although FIG. 28 illustrates one example method 2800 for resource management preemption, various changes may be made to FIG. 28. For example, while shown as a series of steps, various steps in FIG. 28 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A first electronic device comprising:
a transceiver configured to, during a transmission opportunity (TXOP) held by the first electronic device:
receive, from a second electronic device, a low latency (LL) indication (LLI) indicating an LL traffic (LLT) request of the second electronic device corresponding with at least of one of an uplink (UL) traffic request, a downlink (DL) traffic request, and a peer-to-peer (P2P) traffic request; and
transmit, in response to receipt of the LLI, an indication for one of a reverse direction grant (RDG) or TXOP sharing for the second electronic device; and
a processor operably coupled to the transceiver, the processor configured to cause the first electronic device to refrain from transmitting non-LL data within the TXOP during an LLT window,
wherein the LLT window is a duration within the TXOP corresponding with the RDG or TXOP sharing in which the second electronic device may exchange the LLT or P2P traffic.

2. The first electronic device of claim 1, wherein:
the LLI includes an LLT request; and
the processor is further configured to:
determine a policy action based on the LLT request included in the LLI; and
cause the transceiver to perform the policy action.

3. The first electronic device of claim 1, wherein:
the LLI includes a P2P request; and
the processor is further configured to:
determine a policy action based on the P2P request included in the LLI; and
cause the transceiver to perform the policy action.

4. The first electronic device of claim 1, wherein:
the LLI includes urgency information; and
the processor is further configured to:
determine an expiration time based on the urgency information included in the LLI; and
cause the transceiver to perform a policy action.

5. The first electronic device of claim 1, wherein the LLI and LLT window are determined based on a negotiation between the first electronic device and the second electronic device.

6. The first electronic device of claim 1, wherein the processor is further configured to determine the LLT window based on at least one of:
a queue status;
a latency constraint; and
a QoS requirement.

7. The first electronic device of claim 6, wherein:
the LLI includes an indication of a long LLT; and
the processor is further configured to determine the LLT window based on the indication of the long LLT.

8. The first electronic device of claim 1, wherein:
the LLI includes a request for additional time or an additional TXOP; and
the transceiver is further configured to, during a later TXOP held by the first electronic device, transmit an additional time for LLT indication for the second electronic device.

9. The first electronic device of claim 1, wherein:
the transceiver is further configured to, prior to the TXOP held by the first electronic device:
receive, from the second electronic device, a setup request; and
transmit, to the second electronic device, a setup response indicating acceptance of an LL session; and
the transceiver is further configured to, after the TXOP held by the first electronic device:
receive, from the second electronic device, a teardown request; and
transmit, to the second electronic device, a teardown response indicating teardown of the LL session.

10. The first electronic device of claim 1, wherein:
the transceiver is further configured to, prior to the TXOP held by the first electronic device:
receive, from a third electronic device, a request for the second electronic device; and
transmit, to the third electronic device, a setup response indicating acceptance of an LL session; and
the transceiver is further configured to, after the TXOP held by the first electronic device:
receive, from the third electronic device, a teardown request for the second electronic device; and
transmit, to the third electronic device, a teardown response indicating teardown of the LL session.

11. A second electronic device comprising:
a processor; and
a transceiver operably coupled to the processor, the transceiver configured to, during a transmission opportunity (TXOP) held by a first electronic device:
transmit, to the first electronic device, a low latency (LL) indication (LLI) indicating an LL traffic (LLT) request of the second electronic device corresponding with at least one of an uplink (UL) traffic request, a downlink (DL) traffic request, and a peer-to-peer (P2P) traffic request;
receive, from the first electronic device, an indication for one of a reverse direction grant (RDG) or TXOP sharing for the second electronic device; and
transmit, during an LLT window, the at least one of LLT or P2P traffic,
wherein the LLT window is a duration within the TXOP corresponding with the RDG or TXOP sharing in which the second electronic device may exchange the LLT or P2P traffic.

12. The second electronic device of claim 11, wherein:
the LLI includes a LLT request; and
the transceiver is further configured to receive a message corresponding with a policy action determined by the first electronic device based on the LLT request.

13. The second electronic device of claim 11, wherein:
the LLI includes a P2P request; and
the transceiver is further configured to receive a message corresponding with a policy action determined by the first electronic device based on the P2P request.

14. The second electronic device of claim 11, wherein:
the LLI includes urgency information; and
the transceiver is further configured to receive, before an expiration time determined by the first electronic device based on the urgency information, a message corresponding with a policy action.

15. The second electronic device of claim 11, wherein the LLI and LLT window are determined based on a negotiation between the first electronic device and the second electronic device.

16. The second electronic device of claim 11, wherein the processor is configured to determine the LLT window based on at least one of:
a queue status;
a latency constraint; and
a QoS requirement.

17. The second electronic device of claim 16, wherein the LLI includes an indication of a long LLT.

18. The second electronic device of claim 11, wherein:
the LLI includes a request for additional time or an additional TXOP; and
the transceiver is further configured to, during a later TXOP held by the first electronic device, receive an additional time for LLT indication for the second electronic device.

19. The second electronic device of claim 11, wherein:
the transceiver is further configured to, prior to the TXOP held by the first electronic device:
transmit, to the first electronic device, a setup request; and
receive, from the first electronic device, a setup response indicating acceptance of an LL session; and
the transceiver is further configured to, after the TXOP held by the first electronic device:
transmit, to the first electronic device, a teardown request; and
receive, from the first electronic device, a teardown response indicating teardown of the LL session.

20. The second electronic device of claim 11, wherein:
the transceiver is further configured to, prior to the TXOP held by the first electronic device:
transmit, to a third electronic device, a setup request for the second electronic device; and
receive, from the third electronic device, a setup response indicating acceptance of an LL session; and
the transceiver is further configured to, after the TXOP held by the first electronic device:
receive, from the third electronic device, a teardown request for the second electronic device; and
transmit, to the third electronic device, a teardown response indicating teardown of the LL session.
